(19) United States
(12) Patent Application Publication
(10) Pub. No.: US 2026/0042629 A1
(43) Pub. Date: Feb. 12, 2026

(54) SHEET CONVEYANCE APPARATUS AND IMAGE FORMING APPARATUS

(71) Applicant: CANON KABUSHIKI KAISHA, Tokyo (JP)

(72) Inventors: Masashi TAKANO, Chiba (JP); Wataru TAKAHASHI, Chiba (JP)

(21) Appl. No.: 19/287,693

(22) Filed: Jul. 31, 2025

(30) Foreign Application Priority Data
Aug. 8, 2024 (JP) 2024-133340

(51) Int. Cl. B65H 9/10; B65H 9/00; G03G 15/00

(52) U.S. Cl. CPC B65H 9/106; B65H 9/006; G03G 15/6567; B65H 2404/1441; B65H 2801/06; G03G 2215/00565; G03G 2215/00679

(57) ABSTRACT

A sheet conveyance apparatus includes a first conveying rotary member pair, an abutment portion, a first skewing rotary member pair, a second skewing rotary member pair, a switching mechanism, and a control unit. The control unit executes a first mode of controlling the second skewing rotary member pair to be in a nipping state in a sheet oblique conveyance state which is a state from when the first skewing rotary member pair starts an oblique conveyance of the sheet having been conveyed by the first conveying rotary member pair until an edge portion in a width direction of the sheet abuts the abutment portion, and a second mode of controlling the second skewing rotary member pair to be in a non-nipping state in the sheet oblique conveyance state.

### BACKGROUND

### Field of the Technology

The present disclosure relates to sheet conveyance apparatuses for conveying sheets, and to image forming apparatuses.

### Description of the Related Art

In image forming apparatuses such as printers, there has been proposed an apparatus that adopts a so-called side registration system in which skewing of sheets is corrected by obliquely conveying sheets using a skewing roller pair and abutting an end portion of the sheet against an abutment member (refer to Japanese Patent Application Laid-Open Publication No. 2022-10326). According to the apparatus taught in Japanese Patent Application Laid-Open Publication No. 2022-10326, the sheet having been conveyed by a conveyance roller pair is abutted against a reference surface of a reference member by a plurality of skewing rollers, and thereafter, the sheet is conveyed to a registration roller pair. Japanese Patent Application Laid-Open Publication No. 2022-10326 proposes, after abutting the sheet against the reference member, possibly releasing the pressure of one or two skewing roller pairs among the plurality of skewing roller pairs disposed on a front side, so as to balance the moments generated by the skewing roller pairs disposed on a back side and the plurality of skewing roller pairs disposed on the front side.

According to the technique disclosed in Japanese Patent Application Laid-Open Publication No. 2022-10326, a sufficient conveyance force is required to abut sheets such as normal paper or thick paper reliably against the reference member, such that a plurality of skewing roller pairs are used to nip and obliquely convey the sheet to abut the sheet against the reference member. However, if the sheet being obliquely conveyed is a sheet having a small grammage and a low rigidity, such as thin paper, the force that abuts the sheet against the reference member may be too strong and the sheet may be buckled, according to which the accuracy of skew correction may be deteriorated.

### SUMMARY

The present disclosure provides a sheet conveyance apparatus and an image forming apparatus capable of preventing deterioration of accuracy of skew correction.

According to a first aspect of the present disclosure, a sheet conveyance apparatus includes a first conveying rotary member pair configured to nip and convey a sheet, an abutment portion arranged on one side in a width direction orthogonal to a sheet conveyance direction with respect to the sheet being conveyed, a first skewing rotary member pair arranged downstream of the first conveying rotary member pair in the sheet conveyance direction and configured to obliquely convey the sheet toward the abutment portion, a second skewing rotary member pair arranged downstream of the first conveying rotary member pair in the sheet conveyance direction and configured to obliquely convey the sheet toward the abutment portion, a switching mechanism configured to switch the second skewing rotary member pair between a nipping state in which the sheet is nipped and conveyed and a non-nipping state in which the nipping of the sheet is released, and a control unit configured to control the switching mechanism. The control unit is configured to execute a first mode of controlling the second skewing rotary member pair to be in the nipping state in a sheet oblique conveyance state which is a state from when the first skewing rotary member pair starts an oblique conveyance of the sheet having been conveyed by the first conveying rotary member pair until an edge portion in the width direction of the sheet abuts the abutment portion, and a second mode of controlling the second skewing rotary member pair to be in the non-nipping state in the sheet oblique conveyance state.

According to a second aspect of the present disclosure, an image forming apparatus includes the sheet conveyance apparatus, and an image forming unit arranged downstream of the sheet conveyance apparatus in the sheet conveyance direction, and configured to form an image on the sheet.

Features of the present disclosure will become apparent from the following description of embodiments with reference to the attached drawings. The following description of embodiments are described by way of example.

### BRIEF DESCRIPTION OF THE DRAWINGS

FIG. 1 is a schematic drawing of a printer according to a first embodiment.

FIG. 2 is a top view of a registration unit according to the first embodiment.

FIG. 3A is a cross-sectional view of a conveyance unit in a nipping state in the registration unit.

FIG. 3B is a cross-sectional view of a conveyance unit in a non-nipping state in the registration unit.

FIG. 4 is a perspective view of a portion of the conveyance unit in the registration unit.

FIG. 5A is a top view of a portion of a skew feed correcting unit in the registration unit.

FIG. 5B is a cross-sectional view of a portion of the skew feed correcting unit in the registration unit viewed in a sheet conveyance direction.

FIG. 6A is a perspective view of a skewing roller pair and a pressurization mechanism thereof.

FIG. 6B is a side view of the skewing roller pair and a portion of the pressurization mechanism thereof.

FIG. 7A is a side view of the skewing roller pair in the nipping state.

FIG. 7B is a side view of the skewing roller pair in the non-nipping state.

FIG. 8 is a perspective view of a sheet position detection sensor in the conveyance unit of the registration unit.

FIG. 9 is a perspective view of a driving mechanism of the conveyance roller pair in the conveyance unit of the registration unit.

FIG. 10 is a perspective view of a slide mechanism of the conveyance roller pair in the conveyance unit of the registration unit.

FIGS. 11A and 11B illustrate a pressure release mechanism of the conveyance roller pair in the conveyance unit of the registration unit, wherein FIG. 11A is a perspective view, and FIG. 11B is a cross-sectional view.

FIG. 12 is a block diagram illustrating a control system of a printer according to the first embodiment.

FIGS. 13A and 13B illustrate a state in which a sheet has been conveyed to the conveyance unit of the registration unit according to the first embodiment, wherein FIG. 13A is a top view, and FIG. 13B is a cross-sectional view.

FIG. 13C is a top view illustrating a state in which the sheet has been conveyed from the state illustrated in FIGS. 13A and 13B to a position conveyable by a conveyance roller pair 34-4.

FIG. 13D is a cross-sectional view of the state illustrated in FIG. 13C.

FIG. 14A is a top view illustrating a state in which skew correction has been performed in the skew feed correcting unit of the registration unit according to the first embodiment.

FIG. 14B is a cross-sectional view of the state illustrated in FIG. 14A.

FIG. 15A is a top view illustrating a state in which shifting has been performed by a registration roller pair of the registration unit according to the first embodiment.

FIG. 15B is a cross-sectional view of the state illustrated in FIG. 15A.

FIG. 16 is a flowchart illustrating a control of the conveyance unit of the registration unit during execution of a regular print job according to the first embodiment.

FIG. 17 is a flowchart illustrating the control of the skew feed correcting unit and the registration roller pair of the registration unit during execution of the regular print job according to the first embodiment.

FIG. 18 is a flowchart illustrating a mode determination control of the skewing roller pair according to the first embodiment.

FIG. 19 is a schematic cross-sectional view illustrating a state of the skew feed correcting unit in a second mode according to the first embodiment.

FIG. 20 is a flowchart illustrating a mode determination control of a skewing roller pair according to a second embodiment.

FIG. 21 is a schematic cross-sectional view illustrating a state of a skew feed correcting unit in a second mode according to the second embodiment.

### DESCRIPTION OF THE EMBODIMENTS

### First Embodiment

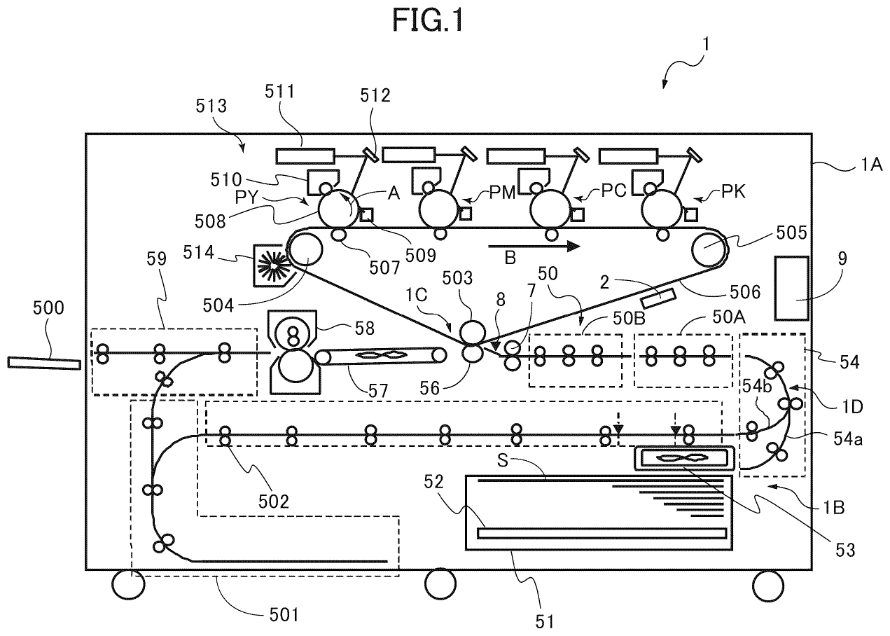

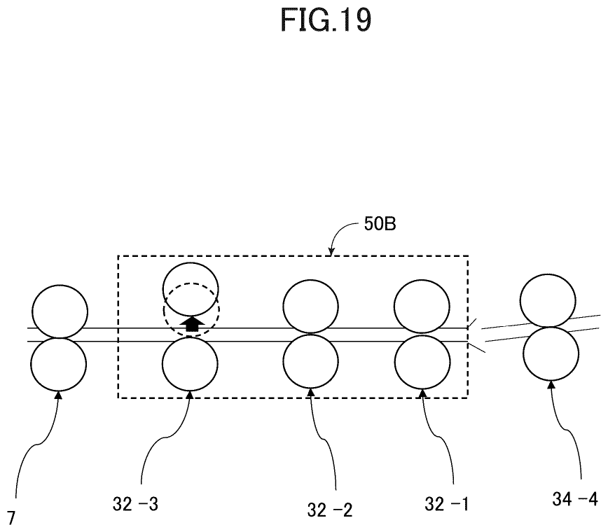

A first embodiment will be described below with reference to FIGS. 1 to 19. At first, a schematic configuration of a printer 1 serving as an image forming apparatus equipped with a registration unit 50 as a sheet conveyance apparatus according to the present first embodiment will be described. FIG. 1 is a schematic drawing illustrating an image forming apparatus according to the first embodiment. In the printer 1, various sheets may be used as a recording medium, including paper such as normal paper and envelopes, glossy paper, plastic films such as overhead projector sheets, and cloths.

### Configuration of Image Forming Apparatus

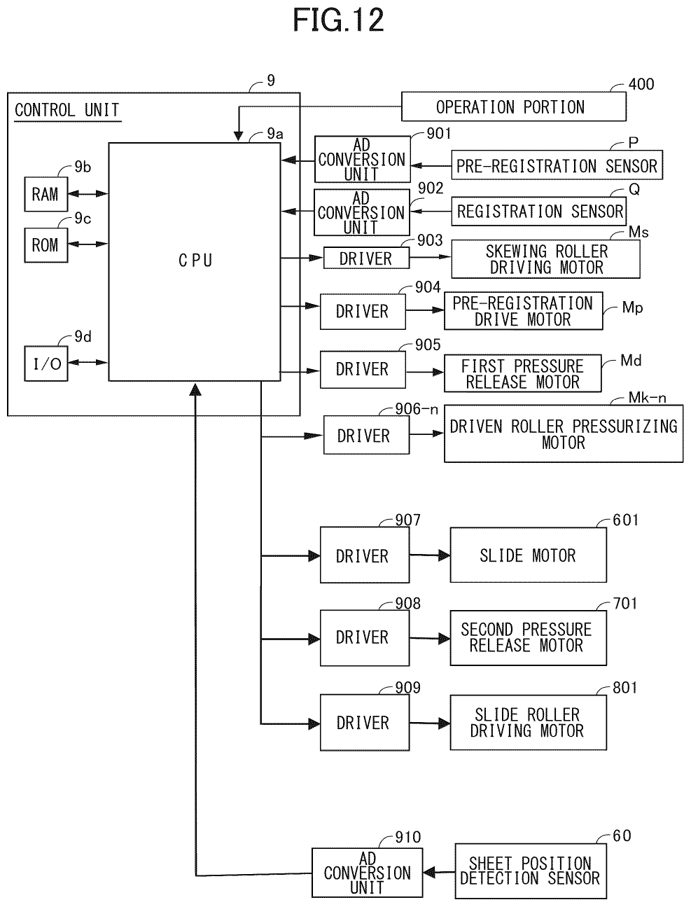

As illustrated in FIG. 1, the printer 1 includes a control unit 9 (refer to FIG. 12) that controls an overall operation of the printer 1 based on image information entered from an external PC or image information read from a document. An apparatus body 1A of the printer 1 accommodates a sheet feed cassette 51 storing sheets S, and an image forming engine 513 serving as an image forming unit for forming images on the sheet S being fed from the sheet feed cassette 51. The image forming engine 513 serving as an example of an image forming unit is equipped with four image forming processing units PY, PM, PC, and PK for forming toner images of yellow, magenta, cyan, and black, and an intermediate transfer belt 506 serving as an image bearing member. The image forming engine 513 forms an image on the sheet S by a tandem intermediate transfer system. The image forming processing units PY to PK are each an electrophotographic unit including a photosensitive drum 508 serving as a photosensitive member.

The configurations other than the toner colors used for developing the image are the same among the image forming processing units PY to PK. The image forming processing unit PY of yellow is taken as an example to describe the configuration of the image forming engine 513 and the image forming process of the toner image below. In addition to the photosensitive drum 508, the image forming processing unit PY includes an exposing unit 511, a developing unit 510, and a drum cleaner 509. The photosensitive drum 508 is a drum-shaped photosensitive member having a photosensitive layer on an outer circumference portion, and rotates in a direction, i.e., arrow A of FIG. 1, along a direction of rotation of the intermediate transfer belt 506, i.e., arrow B of FIG. 1. The surface of the photosensitive drum 508 is charged by receiving supply of electric charge from a charging unit such as a charging roller not shown. The exposing unit 511 irradiates laser beams having been modulated according to the image information, scans the photosensitive drum 508 by an optical system including a reflector 512, and forms an electrostatic latent image on the surface of the photosensitive drum 508. Developer containing toner is stored in the developing unit 510, and toner is supplied to the photosensitive drum 508, by which the electrostatic latent image is visualized as a toner image. The toner image formed on the photosensitive drum 508 is primarily transferred to the intermediate transfer belt 506 at a primary transfer portion serving as a nip portion between a primary transfer roller 507 and the intermediate transfer belt 506. Residual toner remaining on the photosensitive drum 508 after transfer is removed by the drum cleaner 509.

The intermediate transfer belt 506 is wound around a drive roller 504, a driven roller 505, a secondary transfer inner roller 503, and the primary transfer roller 507, and is driven to rotate in a clockwise direction of FIG. 1, i.e., arrow B direction, by the drive roller 504. The image forming process described above is performed in parallel in the respective image forming processing units PY to PK, and the toner images of four colors are transferred in multiple layers in a superposed manner, such that a full-color toner image is formed on the intermediate transfer belt 506. The toner image is borne on the intermediate transfer belt 506 and conveyed to a secondary transfer portion 1C. The secondary transfer portion 1C is formed as a nip portion between a secondary transfer roller 56 serving as a transfer roller and the secondary transfer inner roller 503. A bias voltage having an opposite polarity as a charge polarity of toner is applied to the secondary transfer roller 56, by which the toner image is secondarily transferred to the sheet S. Residual toner remaining on the intermediate transfer belt 506 after transfer is removed by a belt cleaner 514.

The sheet S having the toner image transferred thereto is conveyed by a pre-fixing conveyance unit 57 to a fixing unit 58. The fixing unit 58 includes a fixing roller pair that nips and conveys the sheet S, and a heat source such as a halogen heater, by which pressure and heat are applied to the toner image borne on the sheet S. Thereby, toner particles are melted and solidified, and the toner image is fixed to the sheet S.

Next, a sheet conveyance process for conveying sheets will be described. A sheet conveyance system 1D of the printer 1 conveys the sheet S fed from a sheet feed unit 1B serving as a sheet feeding apparatus, and discharges the sheet S on which an image has been formed to an exterior of the apparatus body 1A. The sheet conveyance system 1D includes a sheet conveyance unit 54, the registration unit 50, the pre-fixing conveyance unit 57, a branch conveyance unit 59, a reverse conveyance unit 501, and a duplex conveyance unit 502.

The sheet feed cassette 51 disposed on the sheet feed unit 1B is attached in a drawable manner to the apparatus body 1A, in which are stored sheets S in a manner stacked and supported on a tray 52 that may be elevated and lowered, and the sheets S are fed one by one by a sheet feeding portion 53. The sheet feeding portion 53 may adopt a belt system in which the sheet S is sucked onto a belt member by a suction fan and conveyed thereon, or a friction separation system that adopts a roller or a pad. The sheet S sent out from the sheet feeding portion 53 is conveyed along a sheet feeding path 54a by a conveyance roller pair of the sheet conveyance unit 54, and is transferred to the registration unit 50.

The sheet S having been sent to the registration unit 50 is conveyed toward the secondary transfer portion 1C after being subjected to skew correction and timing correction. In this state, a registration roller pair 7 of the registration unit 50 sends the sheet S to the secondary transfer portion 1C at a corresponding timing with the image forming processes performed by the image forming processing units PY to PK based on the detection of the sheet by a sheet detection sensor 8. The sheet S to which a toner image has been transferred at the secondary transfer portion 1C and to which the image has been fixed by the fixing unit 58 is conveyed to the branch conveyance unit 59 by which the conveyance path of the sheet S is branched. If forming of image to the sheet S is completed, the sheet S is discharged by a sheet discharge roller pair onto a sheet discharge tray 500 arranged outside the apparatus body 1A.

Meanwhile, if an image is to be formed on a rear surface of the sheet S, the sheet S is conveyed via the reverse conveyance unit 501 to the duplex conveyance unit 502. The reverse conveyance unit 501 includes a reverse conveyance roller pair that may be rotated in both normal and reverse directions, and the sheet is reversed by a switchback system in which the front and rear surfaces of the sheet S are reversed. That is, after retreating a leading edge of the sheet, the reverse conveyance unit 501 reverses the sheet conveyance direction to reverse the sheet, and then conveys the sheet to the duplex conveyance unit 502. The duplex conveyance unit 502 conveys the sheet S again toward the registration unit 50 via a sheet feed path 54b of the sheet conveyance unit 54. After having an image formed on a rear surface thereof, the sheet S is discharged onto the sheet discharge tray 500.

### Configuration of Registration Unit

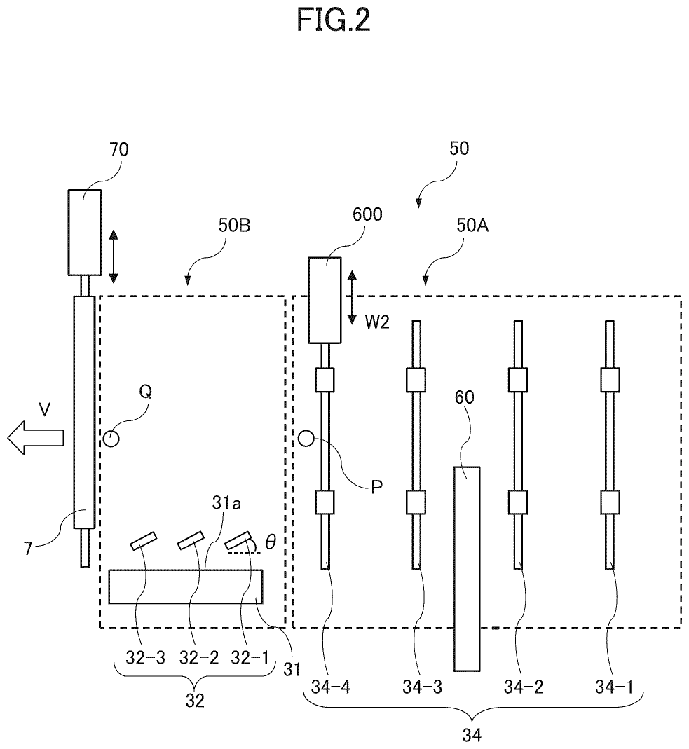

Next, with reference to FIG. 2, a configuration of the registration unit 50 that constitutes the sheet conveyance apparatus will be described with reference to FIG. 2. FIG. 2 is a top view illustrating a registration unit. The registration unit 50 according to the present embodiment is a unit in which the sheet is subjected to skew correction by side registration.

Specifically, as illustrated in FIG. 2, the registration unit 50 includes, in the named order from upstream to downstream in the sheet conveyance direction, a conveyance unit 50A, a skew feed correcting unit 50B, and the registration roller pair 7. Further, the registration unit 50 includes a sheet position detection sensor 60 serving as a width position detecting unit that detects a position of an edge portion of a sheet in a width direction orthogonal to the sheet conveyance direction. Further, the registration unit 50 includes a slide mechanism 600 that moves one of the plurality of conveyance roller pairs of the conveyance unit 50A in a width direction orthogonal to the sheet conveyance direction. The conveyance unit 50A includes at least one set of conveyance roller pairs that convey the sheet in the sheet conveyance direction, and in FIG. 2, a configuration equipped with conveyance roller pairs 34-1, 34-2, 34-3, and 34-4 is illustrated. In the following description, if there is no need to distinguish the conveyance roller pairs 34-1, 34-2, 34-3, and 34-4, they are collectively referred to as the “conveyance roller pair 34”.

In the registration unit 50 of the present embodiment, the slide mechanism 600 serving as a first movement unit is disposed on the conveyance roller pair 34-4 serving as a first conveying rotary member pair. Further, in FIG. 2, a configuration is illustrated in which the sheet position detection sensor 60 is disposed between the conveyance roller pair 34-2 and the conveyance roller pair 34-3. Other than the configuration illustrated in FIG. 2, the sheet position detection sensor 60 may also be disposed at a position capable of detecting the edge portion in the width direction of the sheet that is conveyed in the conveyance unit 50A, such as at a position between the conveyance roller pair 34-4 and the conveyance roller pair 34-3.

The skew feed correcting unit 50B includes skewing roller pairs 32-1, 32-2, and 32-3 serving as skewing rotary member pairs, and a reference member 31 serving as an abutment portion. The skewing roller pairs 32-1, 32-2, and 32-3 are arranged along a straight line approximately facing a sheet conveyance direction V. In other words, the skewing roller pairs 32-1, 32-2, and 32-3 are arranged such that at least a portion thereof are mutually overlapped when viewed in the sheet conveyance direction V. That is, the skewing roller pair 32-3 is arranged at a position where at least a portion of the skewing roller pair 32-3 overlaps with the skewing roller pair 32-1 when viewed in the sheet conveyance direction V. Also, the skewing roller pair 32-2 is arranged at a position where at least a portion of the skewing roller pair 32-2 overlaps with the skewing roller pair 32-3 when viewed in the sheet conveyance direction V. According to the present first embodiment, the skewing roller pair 32-1 constitutes a first skewing rotary member pair, the skewing roller pair 32-3 constitutes a second skewing rotary member pair, and the skewing roller pair 32-2 constitutes a third skewing rotary member pair. In the following description, if there is no need to distinguish the skewing roller pairs 32-1, 32-2, and 32-3, they are collectively referred to as the “skewing roller pair 32”. The reference member 31 includes a reference surface 31a that extends in the sheet conveyance direction, and it is arranged on one side in the width direction orthogonal to the sheet conveyance direction. The reference surface 31a serves as an abutment surface that extends along the sheet conveyance direction and against which one edge portion of the sheet may be abutted.

A pre-registration sensor P that detects the arrival of the leading edge of the sheet by detecting the presence or absence of a sheet is arranged near the conveyance roller pair 34-4. A reflection-type photoelectric sensor including a light emitting portion and a light receiving portion may be used as the pre-registration sensor P. In that case, the light emitted from the light emitting portion is reflected on the sheet having reached the detection position, and by the light receiving portion detecting the reflected light, a sheet passing timing is detected. As illustrated in FIG. 2, according to the present embodiment, the pre-registration sensor P is arranged between the conveyance roller pair 34-4 and the skewing roller pair 32-1 in the sheet conveyance direction. The pre-registration sensor P serves as an example of a detecting unit that detects that the sheet has arrived at the registration roller pair 7.

The skewing roller pairs 32-1, 32-2, and 32-3 respectively rotate about an axis inclined with respect to the width direction. That is, the skewing roller pairs 32-1, 32-2, and 32-3 are arranged in parallel with each other such that a tangential direction at a contact portion with respect to a sheet is set to a direction inclined by angle θ with respect to the sheet conveyance direction V. Therefore, by abutting against the sheet and rotating, the skewing roller pairs 32-1, 32-2, and 32-3 move the sheet such that the sheet becomes close to the reference surface 31a of the reference member 31 in the width direction toward the downstream side in the sheet conveyance direction V. Further, the sheet is moved in a direction approaching the reference surface 31a as the sheet is conveyed downstream in the sheet conveyance direction V by the skewing roller pair 32.

The skew correction of the sheet by the skew feed correcting unit 50B will be described. The skew feed correcting unit 50B corrects skewing of the sheet by a so-called side registration system. Specifically, the skew feed correcting unit 50B causes a side edge of the sheet, that is, a sheet edge portion in the width direction, to be abutted against the reference member 31 having the reference surface 31a extending along the sheet conveyance direction V. After having the sheet abut against the reference surface 31a, the side edge of the sheet is moved along the reference surface 31a, by which the skewing of the sheet is corrected. The sheet conveyance direction V refers to an advancing direction of the sheet by the conveyance roller pair 34 of the conveyance unit 50A, or the advancing direction of the sheet that is conveyed by the registration roller pair 7 toward the secondary transfer portion 1C.

Further, in addition to the pre-registration sensor P, the skew feed correcting unit 50B has a registration sensor Q serving as a detecting unit that detects the arrival of the leading edge of the sheet by detecting the presence or absence of a sheet. The registration sensor Q is arranged downstream of the skewing roller pair 32 and upstream of the registration roller pair 7 with respect to the sheet conveyance direction. Similar to the pre-registration sensor P, the registration sensor Q serves as the example of the detecting unit that detects that the sheet has arrived at the registration roller pair 7. Similar to the pre-registration sensor P, the registration sensor Q may adopt a known sensor, such as a reflection-type photoelectric sensor. Further, the registration sensor Q is a sensor for detecting that the sheet has arrived at the registration roller pair 7. Specifically, after the elapse of a predetermined delay time after the sheet has been detected by the registration sensor Q, it is detected that the sheet has arrived at the registration roller pair 7. In other words, the registration sensor Q has a function to detect the arrival of the sheet at the registration roller pair 7. The registration sensor Q may be arranged downstream of the registration roller pair 7, and in that case, the registration sensor Q will detect that a sheet has already reached the registration roller pair 7.

The registration roller pair 7 serving as a second conveying rotary member pair may be moved to slide in a width direction orthogonal to the sheet conveyance direction in a sheet nipping state by a slide mechanism 70 serving as a second movement unit. The slide mechanism 70 may adopt a similar mechanism as the slide mechanism 600 that moves the conveyance roller pair 34-4 in the width direction. Further, the registration roller pair 7 moves the sheet whose side edge has been abutted against the reference surface 31a of the reference member 31 in the width direction to correspond to the position of the image being transferred at the secondary transfer portion 1C. Thereby, the width-direction center of the sheet being subjected to skew correction in the registration unit 50 moves to correspond to the width-direction center, i.e., width-direction center of an image forming area, of the image being transferred at the secondary transfer portion 1C. The method for performing positional alignment of the sheet and the image to be formed on the sheet is not limited to the above-described method. For example, it is possible to move the sheet by the registration roller pair 7 such that the center of the sheet corresponds to the conveyance center line of the printer 1, and to perform adjustment such that the center position in the main scanning direction of the toner image formed by the image forming processing units PY to PK is positioned at the width-direction center.

### Detailed Configuration of Conveyance Unit

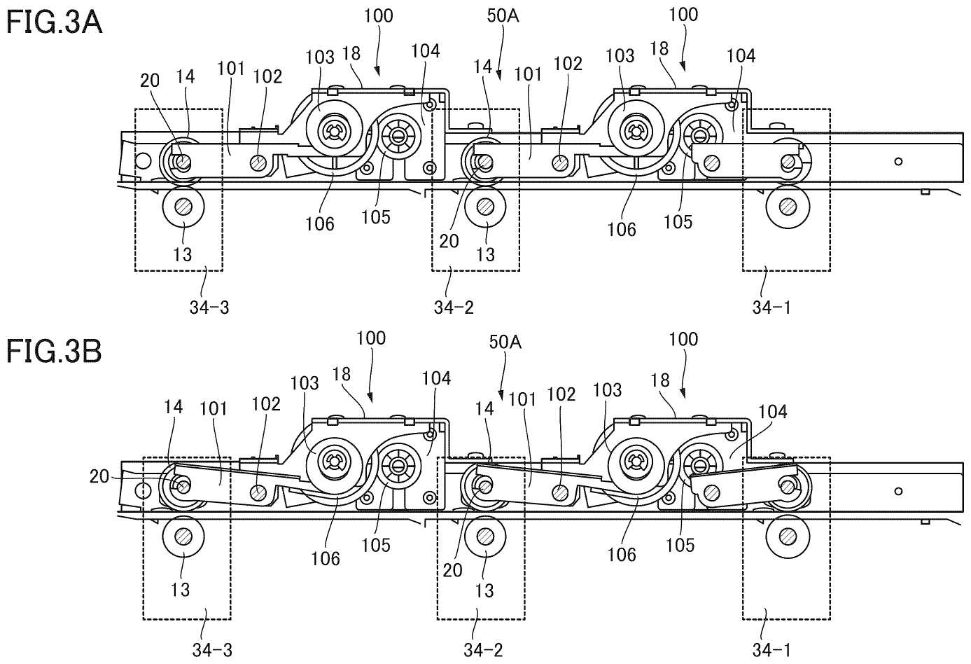

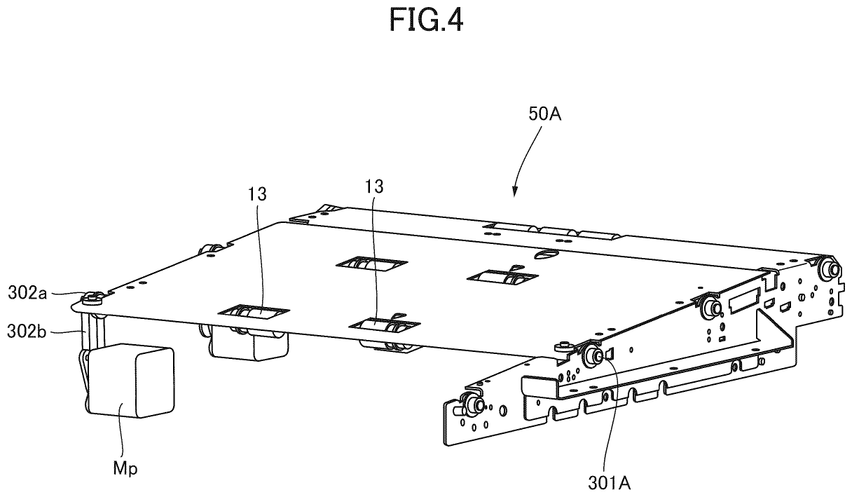

The detailed configuration of the conveyance unit 50A will be described with reference to FIGS. 3A, 3B, and 4. FIG. 3A is a cross-sectional view of a conveyance unit in a nipping state of the registration unit. FIG. 3B is a cross-sectional view of the conveyance unit in a non-nipping state of the registration unit. FIG. 4 is a perspective view of a portion of the conveyance unit of the registration unit. FIGS. 3A and 3B illustrate portions of three of the four conveyance roller pairs 34. According further to the present embodiment, an example is illustrated where the printer 1 has four conveyance roller pairs 34 (refer to FIG. 2), but the number of the conveyance roller pairs is not limited thereto.

As illustrated in FIGS. 3A and 3B, in the conveyance unit 50A, the conveyance roller pairs 34-1, 34-2, and 34-3 each include a driving roller 13 to which a driving force is entered, and a driven roller 14 driven to rotate by the driving roller 13. The conveyance roller pair 34 may be switched between a nipping state in which a sheet may be nipped and conveyed by the nip portion (FIG. 3A) and a non-nipping state in which the nip portion is separated and a sheet is not nipped thereby (FIG. 3B). That is, the non-nipping state is a state in which the nipping of the sheet is released. Whether all the conveyance roller pairs 34 may be switched between the nipping state and the non-nipping state may be determined according to the size of the sheet conveyable by the printer 1.

The conveyance unit 50A includes a cam mechanism 100 that is equipped with an eccentric roller 103 serving as a switching portion capable of switching the conveyance roller pairs 34-1, 34-2, and 34-3 between the nipping state and the non-nipping state. The eccentric roller 103 is driven to rotate by a first pressure release motor Md (refer to FIG. 12) via gears 105 and 106, and causes an arm member 101 that abuts against a cam surface of the outer circumference portion to swing. The arm member 101 is supported swingably with respect to a stay member 18 about a swing shaft 102, the arm member 101 abutting against the eccentric roller 103 on one side of the swing shaft 102 and supporting a driven shaft 20 which is a rotation shaft of the driven roller 14 on the other side thereof. By the swinging of the arm member 101, the driven roller 14 may be retracted from the sheet conveyance path formed by a guide member not shown. Therefore, by controlling the rotation angle of the eccentric roller 103 by the first pressure release motor Md serving as a stepping motor, the positional relationship between the driven roller 14 and the driving roller 13 may be switched. That is, by controlling the rotation angle of the eccentric roller 103, the states may be switched between the non-nipping state in which each of the driven rollers 14 are separated from the driving rollers 13 and the nipping state in which the driven rollers 14 are in pressure contact with the driving rollers 13.

Further, as illustrated in FIG. 4, the driving roller 13 is a rubber roller attached to a driving roller shaft 301A, and is connected to a pre-registration drive motor Mp (refer to FIG. 12) serving as a drive source via a belt drive mechanism 302. The pre-registration drive motor Mp is a stepping motor, and it is configured to enable a timing of starting and stopping of drive and a driving speed of the driving roller 13, i.e., peripheral speed of the driving roller 13, to be varied.

### Detailed Configuration of Skew Correcting Unit

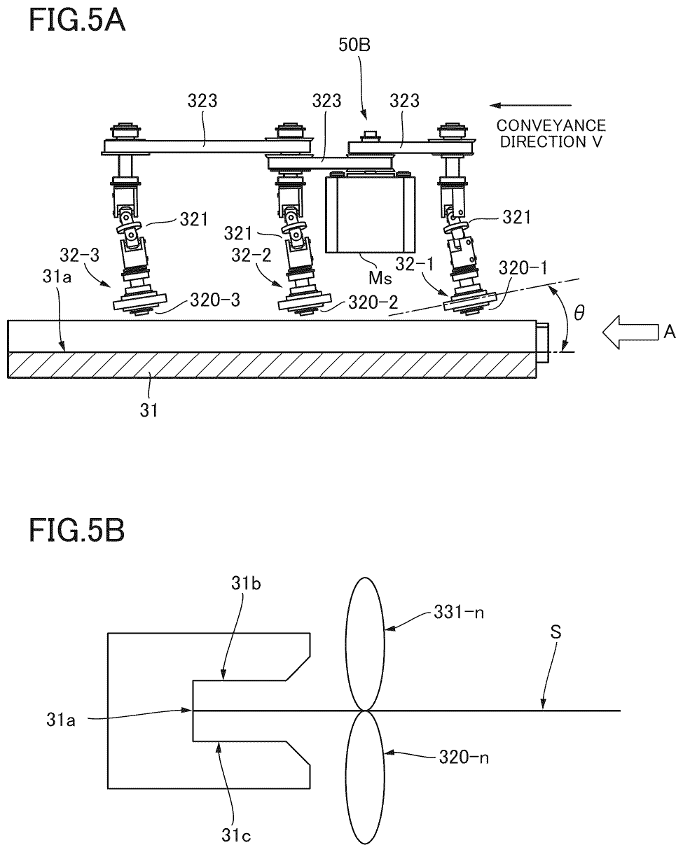

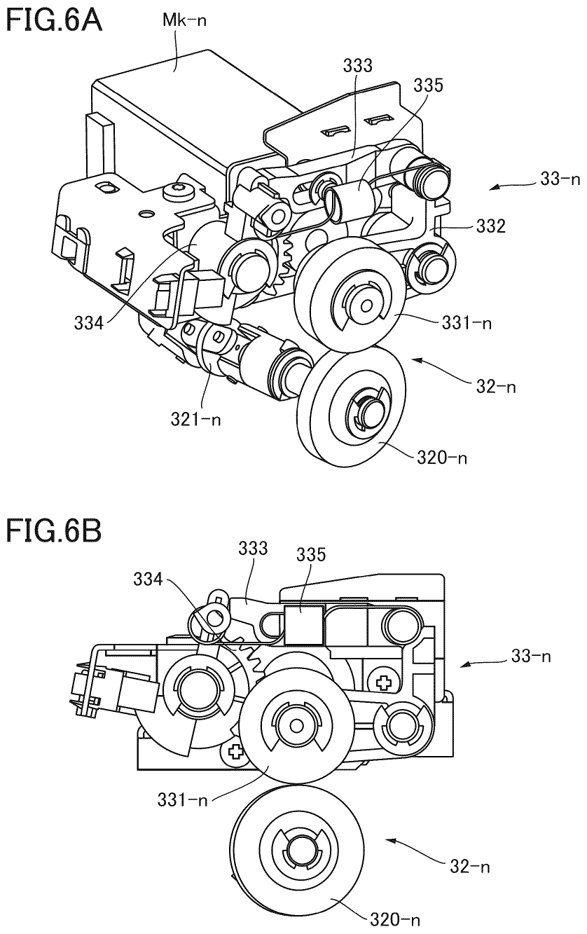

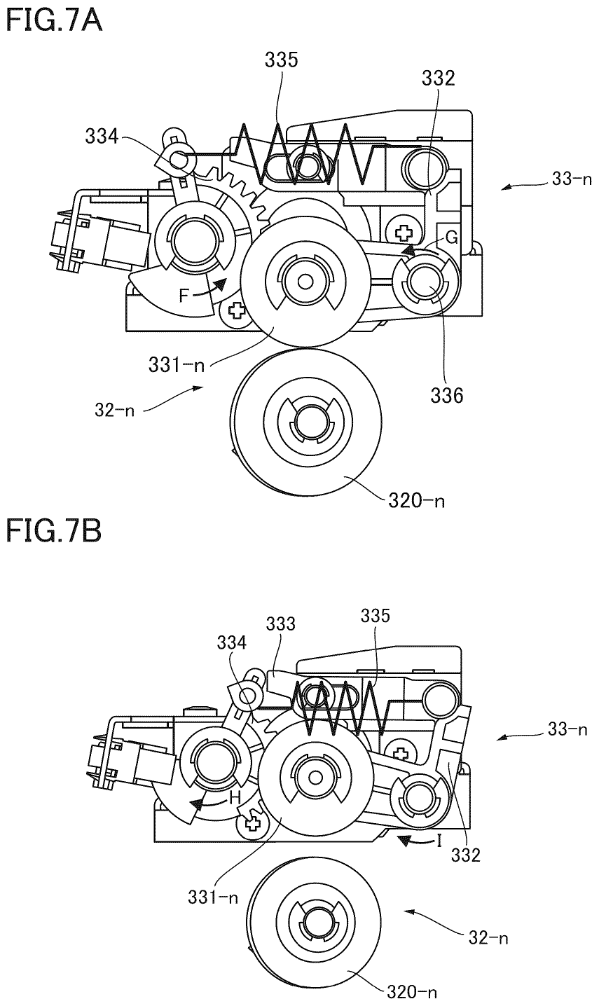

Next, a configuration of the skew feed correcting unit 50B will be described in detail with reference to FIGS. 5A, 5B, 6A, 6B, 7A, and 7B. FIG. 5A is a top view of a portion of the skew feed correcting unit in the registration unit. FIG. 5B is a cross-sectional view in which a portion of the skew feed correcting unit in the registration unit is viewed in the sheet conveyance direction. FIG. 6A is a perspective view illustrating the skewing roller pair and a pressurization mechanism thereof. FIG. 6B is a side view of the skewing roller pair and a pressurization mechanism thereof. FIG. 7A is a side view of the skewing roller pair in the nipping state. FIG. 7B is a side view of the skewing roller pair in the non-nipping state.

As illustrated in FIG. 5A, the skewing roller pairs 32-1, 32-2, and 32-3 are arranged in the skew feed correcting unit 50B, and each of the skewing roller pairs 32-1, 32-2, and 32-3 includes driving rollers 320-1, 320-2, and 320-3. The driving rollers 320-1, 320-2, and 320-3 have their rotational axes fixed in an inclined state corresponding to angle θ by universal joints 321, 321, and 321. If there is no need to distinguish the driving rollers 320-1, 320-2, and 320-3, they are collectively referred to as the “driving roller 320-n”.

Each driving roller 320-n is connected via a transmission mechanism including the universal joint 321, a belt 323, and a pulley to a skewing roller driving motor Ms (refer to FIG. 12) serving as a driving source. The skewing roller driving motor Ms is a stepping motor capable of controlling the driving speed or the timing of starting and stopping of driving of the driving roller 320-n.

As illustrated in FIG. 5B, the reference member 31 has a concaved cross-section composed of the reference surface 31a against which a side edge of the sheet S abuts, an upper opposing surface 31b that faces the upper surface of the sheet S, and a lower opposing surface 31c that faces the lower surface of the sheet S. As the reference member 31, a member formed of an aluminum die-cast, with the reference surface 31a highly accurately processed by a cutting process, and having fluororesin such as polytetrafluoroethylene (PTFE) applied on the reference surface 31a by electroless nickel plating may be adopted. Thereby, the reference surface 31a having a high flatness and high slidability, i.e., small frictional resistance against sheets, may be obtained, and the accuracy of skew correction of sheets S may be realized.

As illustrated in FIGS. 6A, 6B, 7A, and 7B, the skewing roller pair 32-n arranged in the skew feed correcting unit 50B includes the driving roller 320-n, and a driven roller 331-n opposed thereto. Further, the skew feed correcting unit 50B includes a pressurization mechanism 33-n that moves the driven roller 331-n. The pressurization mechanism 33-n includes a pressurization mechanism 33-1 that moves a driven roller 331-1 of the skewing roller pair 32-1. Further, the pressurization mechanism 33-n includes a pressurization mechanism 33-2 that moves a driven roller 331-2 of the skewing roller pair 32-2, and a pressurization mechanism 33-3 that moves a driven roller 331-3 of the skewing roller pair 32-3. According to the present embodiment, the pressurization mechanism 33-1 constitutes a switching mechanism or another switching mechanism, and the pressurization mechanisms 33-2 and 33-3 constitute the switching mechanism. If there is no need to distinguish the pressurization mechanisms 33-1, 33-2, and 33-3, they are collectively referred to as the pressurization mechanism 33-n. The pressurization mechanism 33-n is switchable between a nipping state in which the driven roller 331-n is pressed against the driving roller 320-n to form a nip by which a sheet may be nipped and conveyed, and a non-nipping state in which the driven roller 331-n is separated from the driving roller 320-n.

In the present description, n is a numeral assigned to the skewing roller pair 32, the driven roller 331, and the pressurization mechanism 33 in the named order from the upstream side in the sheet conveyance direction V, and for example, the skewing roller pair 32-1 refers to the skewing roller pair 32 arranged most upstream (n=1). That is, according to the skew feed correcting unit 50B of the present embodiment, multiple sets of driven rollers 331-n and pressurization mechanisms 33-n are arranged in a state where the skewing roller pair 32-n illustrated in FIGS. 6 and 7 is replaced with one of the skewing roller pairs 32-1, 32-2, and 32-3.

The pressurization mechanism 33-n includes an arm member 332, a link member 333, a pressure gear 334, a pressure spring 335, and a driven roller pressurizing motor Mk-n (refer to FIG. 12). The driven roller 331-n is supported rotatably about a driven shaft by the arm member 332, and is movable in a direction approaching or moving away from the skewing roller pair 32-n by the swinging of the arm member 332. The driven roller 331-n according to the present embodiment rotates along the sheet conveyance direction about an axis that extends in the width direction, but it may also adopt a configuration in which the driven roller 331-n is arranged on an axis that is parallel to the corresponding skewing roller pair 32-n. The arm member 332 is connected via the pressure spring 335 and the link member 333 to the pressure gear 334. The pressure gear 334 is connected to an output shaft of the driven roller pressurizing motor Mk-n serving as a driving source.

As illustrated in FIG. 7A, in the nipping state, the pressure gear 334 rotates in a counterclockwise direction in the drawing, and the arm member 332 being pulled by the pressure spring 335 swings in the counterclockwise direction about a swing shaft 332-1. Thereby, the driven roller 331-n will be in a state in pressure contact with the driving roller 320-n. Meanwhile, as illustrated in FIG. 7B, in the non-nipping state, the pressure gear 334 rotates in the clockwise direction in the drawing and presses the link member 333, and the link member 333 causes the arm member 332 to swing in the clockwise direction. Thereby, the driven roller 331-n is separated from the driving roller 320-n.

The driven roller pressurizing motor Mk-n is a stepping motor, and by controlling the rotation angle of the pressure gear 334, the amount of extension of the pressure spring 335 in the pressurizing state may be varied. That is, the pressurization mechanism 33-n according to the present embodiment may be switched between the nipping state and the non-nipping state, and may vary the pressurizing force in the nipping state.

### Configuration of Sheet Position Detection Sensor

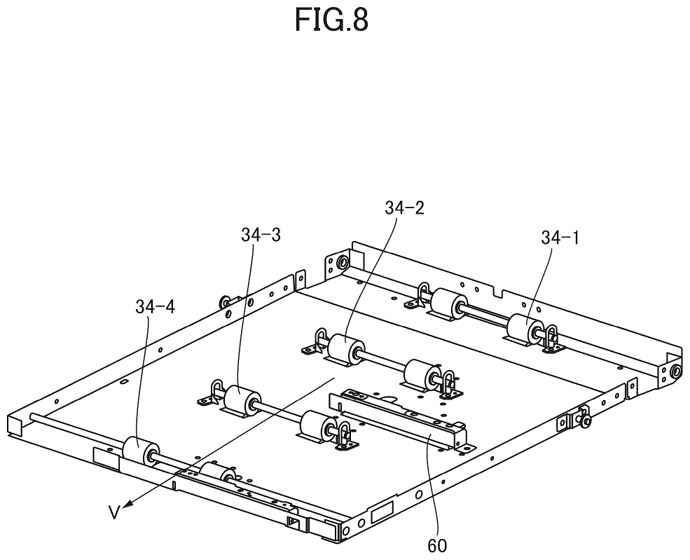

Next, with reference to FIG. 8, a configuration of the sheet position detection sensor 60 serving as a width position detecting unit according to the present embodiment will be described. FIG. 8 is a perspective view illustrating a sheet position detection sensor in a conveyance unit of the registration unit. The sheet position detection sensor 60 is equipped with an optical element such as a Contact Image Sensor (CIS), and is positioned at the same direction as the reference member 31 and at a biased position in the width direction with respect to the width direction center of the sheet in the sheet conveyance direction V. This configuration is adopted to detect the edge portion position of the sheet on the side abutted against the reference member 31.

### Configuration for Driving and Sliding Conveyance Roller Pair

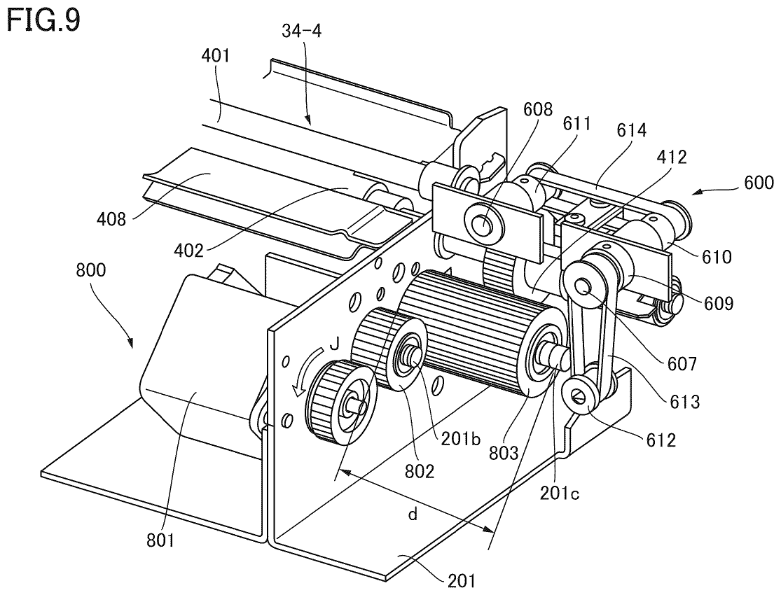

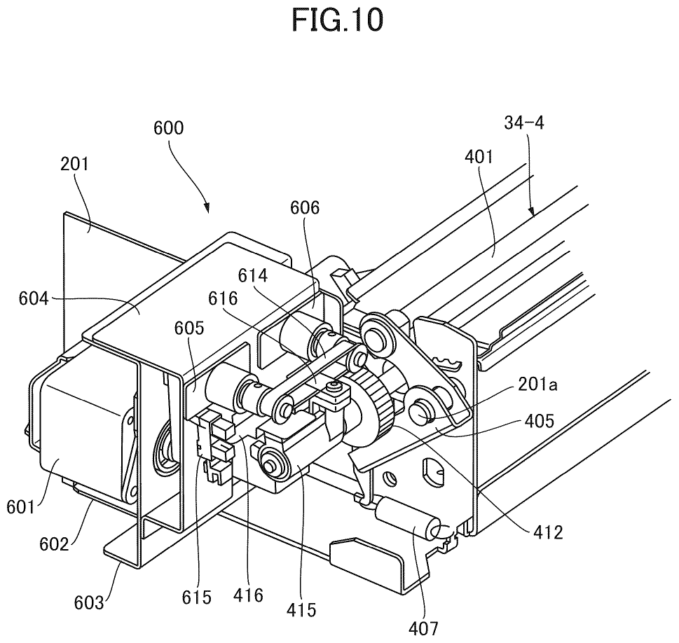

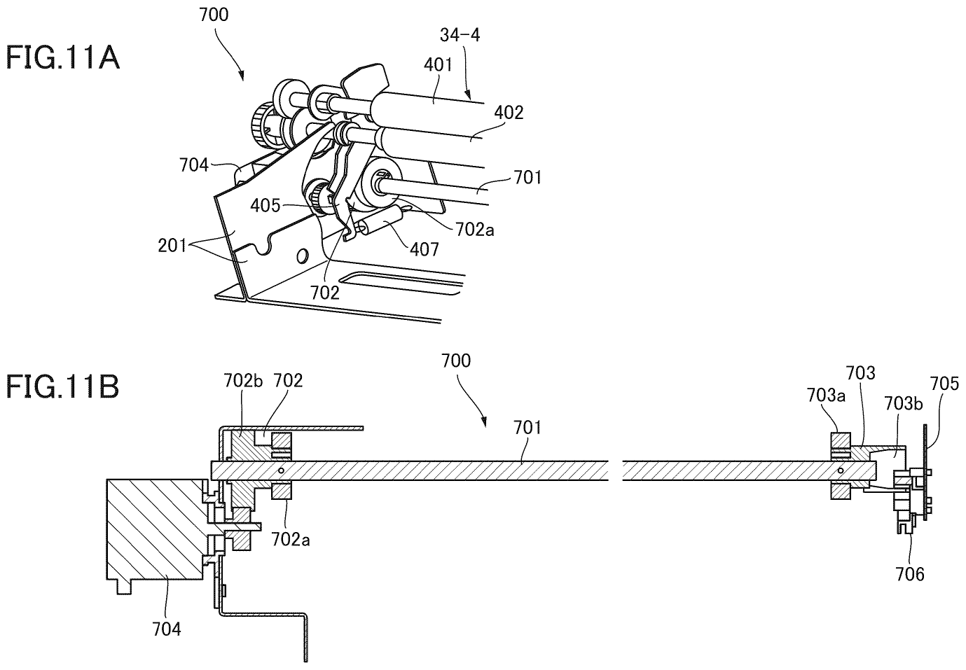

Next, a drive configuration of the conveyance roller pair 34-4 according to the present embodiment, and a configuration of the slide mechanism 600 for sliding the conveyance roller pair 34-4 will be described with reference to FIGS. 9, 10, 11A, and 11B. FIG. 9 is a perspective view of a driving mechanism of a conveyance roller pair in the conveyance unit of the registration unit. FIG. 10 is a perspective view of a slide mechanism of the conveyance roller pair in the conveyance unit of the registration unit. FIG. 11A is a perspective view of a pressure release mechanism of the conveyance roller pair in the conveyance unit of the registration unit. FIG. 11B is a cross-sectional view of the pressure release mechanism of the conveyance roller pair in the conveyance unit of the registration unit.

The conveyance roller pair 34-4 is broadly driven to rotate by a roller driving mechanism 800, and configured movably in the width direction orthogonal to the sheet conveyance direction by the slide mechanism 600 in the sheet nipping state. Further, the conveyance roller pair 34-4 is configured switchably by a pressure release mechanism 700 between a nipping state in which the sheet is nipped between roller pairs constituting the conveyance roller pair 34-4 and a non-nipping state in which the roller pairs are separated.

Specifically, as illustrated in FIG. 10, the conveyance roller pair 34-4 is composed of an upper roller 401 and a lower roller 402 (refer to FIG. 11A). The lower roller 402 is supported rotatably on a frame 201 (refer to FIG. 11A), and the upper roller 401 is supported rotatably on a pressurizing arm 405 (refer to FIG. 10). The pressurizing arm 405 is fixed rotatably by a shaft 201a formed on the frame 201 (refer to FIG. 10). The upper roller 401 is pressed against the lower roller 402 by a tension spring 407. Further, a roller gear 412 that transmits the drive from the roller driving mechanism 800 to the lower roller 402 is fixed to one edge portion of the lower roller 402 (refer to FIG. 9).

The roller driving mechanism 800 that rotates the conveyance roller pair 34-4 is formed to include a slide roller driving motor 801 (refer to FIG. 12), driving gears 802 and 803, and the roller gear 412, as illustrated in FIG. 9. The slide roller driving motor 801 is fixed to the frame 201, and the drive of the slide roller driving motor 801 is transmitted via the driving gears 802 and 803 to the roller gear 412. Further, the driving gear 803 is designed such that a tooth surface of the driving gear 803 is formed to have a length d that is longer than a reciprocating width of the roller gear 412 such that meshing with the roller gear 412 is maintained. The driving gear 802 is fixed rotatably to a fixed shaft 201b and the driving gear 803 is fixed rotatably to a fixed shaft 201c of the frame 201. In the present embodiment, a stepping motor is used as the slide roller driving motor 801. According to such a configuration, the drive of the slide roller driving motor 801 is transmitted to the roller gear 412, and the conveyance roller pair 34-4 is rotated.

The slide mechanism 600 that moves the conveyance roller pair 34-4 in a width direction orthogonal to the sheet conveyance direction includes, as illustrated in FIG. 10, a slide motor 601 (refer to FIG. 12) that is screwed onto a motor support plate 603 in a state fixed to a motor base 602. A pulley support plate 604 is screwed onto an upper portion of the motor support plate 603 via the slide motor 601. Pulley bases 605 and 606 are fixed to the pulley support plate 604. As illustrated in FIG. 9, a pulley shaft 607 is rotatably fixed to the pulley base 605, and a pulley shaft 608 is rotatably fixed to a pulley base 606. Pulleys 609 and 610 are fixed to the pulley shaft 607, and a pulley 611 is fixed to the pulley shaft 608. Further, a pulley 612 is fixed to a leading edge on an output shaft of the slide motor 601. A timing belt 613 is wound around the pulleys 609 and 612, and a timing belt 614 is wound around the pulleys 610 and 611 (refer to FIG. 10).

As illustrated in FIG. 10, a holder 415 is supported rotatably via a bearing at the edge portion on the roller gear 412 side of the lower roller 402. A sensor flag 416 that detects a home position of the upper roller 401 and the lower roller 402 of the conveyance roller pair 34-4 in the width direction is attached to the holder 415. In a state where the upper roller 401 and the lower roller 402 of the conveyance roller pair 34-4 are at the home position, the sensor flag 416 is detected by a sensor 615 disposed on the pulley support plate 604. Further, the holder 415 is fixed to the timing belt 614 by a stopper 616 and a screw not shown. According to this configuration, the timing belt 614 is rotated by the drive of the slide motor 601, and along with the rotation of the timing belt 614, the lower roller 402 of the conveyance roller pair 34-4 moves in reciprocating motion in the width direction orthogonal to the sheet conveyance direction. Further, the upper roller 401 of the conveyance roller pair 34-4 is engaged with the lower roller 402 by an engagement member not shown, and moves together with the lower roller 402 in reciprocating motion in the width direction orthogonal to the sheet conveyance direction. According to the present embodiment, the slide motor 601 is driven and the conveyance roller pair 34-4 is moved in the width direction based on a detection result of the edge portion position of the sheet in the width direction detected by the sheet position detection sensor 60.

The pressure release mechanism 700 for abutting and separating the upper roller 401 and the lower roller 402 of the conveyance roller pair 34-4 includes a pressure release shaft 701 positioned on the frame 201, as illustrated in FIG. 11A. Further, the pressure release mechanism 700 is composed to include cams 702 and 703 fixed to the pressure release shaft 701 (refer to FIG. 11B). The cams 702 and 703 have deep groove ball bearings 702a and 703a that are press-fit to positions eccentric from respective rotation centers, as illustrated in FIG. 11B. Further, as illustrated in FIG. 11A, a gear 702b is formed on the cam 702, and by transmitting the drive of a second pressure release motor 704 (refer to FIG. 12) via the cam 702, the pressure release shaft 701 is rotated.

The deep groove ball bearing 702a is arranged at a position abuttable against the pressurizing arm 405, and in a state where the pressure release shaft 701 is rotated once, the deep groove ball bearing 702a causes the pressurizing arm 405 to swing against the urging force of a spring 407. By causing the pressurizing arm 405 to swing, the upper roller 401 and the lower roller 402 may be abutted against and separated from each other once. A pressurizing arm not shown is also disposed on a side on which the deep groove ball bearing 703a is disposed with respect to the axial direction of the pressure release shaft 701. Further, a sensor flag 703b is formed on the cam 703 (refer to FIG. 11B). A phase of the pressure release shaft 701 is determined by having the sensor flag 703b detected by a sensor 706 fixed to a sensor support plate 705 fixed to the frame 201, and the rotation of the second pressure release motor 704 is controlled according to the phase of the pressure release shaft 701. The phase of the cams 702 and 703 are determined such that the sensor flag 703b blocks the sensor 706 in a state where the upper roller 401 and the lower roller 402 of the conveyance roller pair 34-4 are abutted against one another.

### Configuration of Control System of Printer

Next, a configuration of a control system of the printer 1 will be described with reference to FIG. 12. FIG. 12 is a block diagram illustrating a control system of the printer according to the first embodiment.

As illustrated in FIG. 12, the registration unit 50 in the printer 1 is controlled by the control unit 9. The control unit 9 includes a CPU 9a serving as a calculation unit, a RAM 9b and a ROM 9c serving as storage units, and an interface (I/O) 9d with respect to an external apparatus or a network.

The CPU 9a performs control based on information entered via an operation portion 400 serving as a user interface, or based on detection signals from the pre-registration sensor P and the registration sensor Q described above. Detections signals from the pre-registration sensor P and the registration sensor Q are respectively entered via AD conversion units 901 and 902 to the CPU 9a. Further, the detection signal from the sheet position detection sensor 60 is entered via an AD conversion unit 910 to the CPU 9a. The CPU 9a loads and executes programs stored in the ROM 9c. The CPU 9a performs drive control of a group of motors (Ms, Mp, Md, Mk-n, 601, 701, and 801) which are actuators of the registration unit 50 via drivers 903, 904, 905, 906-n, 907, 908, and 909.

### Outline of Operation of Registration Unit

### Operation of Conveyance Unit

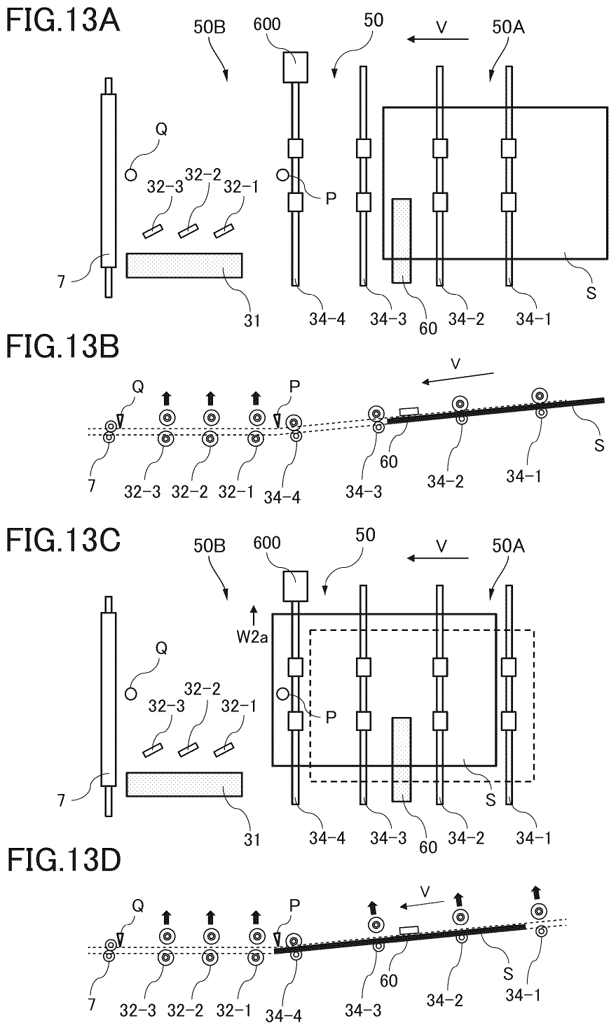

Next, an outline of operation of the registration unit 50 will be described. At first, a shift operation prior to skew correction of the conveyance unit 50A executed prior to skew correction in the registration unit 50 will be described with reference to FIGS. 13A and 13B. FIG. 13A is a top view illustrating a state in which a sheet has been conveyed to the conveyance unit of the registration unit according to the first embodiment. FIG. 13B is a cross-sectional view of the state illustrated in FIG. 13A. FIG. 13C is a top view illustrating a state in which a sheet has been conveyed from the state illustrated in FIGS. 13A and 13B to a position capable of being conveyed by the conveyance roller pair 34-4. FIG. 13D is a cross-sectional view of the state illustrated in FIG. 13C.

As illustrated in FIGS. 13A and 13B, in a state where the sheet S being conveyed in the sheet conveyance direction V in the registration unit 50 reaches the sheet position detection sensor 60, the edge portion position, i.e., side edge position, of the sheet S is detected by the sheet position detection sensor 60. The CPU 9a (refer to FIG. 12) calculates a misalignment amount from a zero point position serving as a reference position of the sheet position detection sensor 60 based on the side edge position of the sheet S being detected, and calculates a shift amount, i.e., shift amount of the shift operation prior to skew correction, in the width direction performed by the conveyance roller pair 34-4.

Next, in a state where the sheet S has reached the conveyance roller pair 34-4 in the nipping state, as illustrated in FIGS. 13C and 13D, the CPU 9a separates the conveyance roller pairs 34-1, 34-2, and 34-3, that is, sets the roller pairs to the non-nipping state. The CPU 9a shifts, i.e., moves, the conveyance roller pair 34-4 in the arrow W2a direction by a shift amount being calculated as above, that is, shifts the sheet S such that the side edge of the sheet S corresponds to the zero point position serving as the reference position of the sheet position detection sensor 60. The zero point position is a set position in which the edge portion position of the sheet in the width direction is separated from the reference member 31 in the width direction. Thereby, the shift operation prior to skew correction is completed, and when skew correction of the sheet S is performed by the skew feed correcting unit 50B, the distance in the width direction between the reference member 31 and the edge portion of the sheet S may be stabilized. In other words, the sliding distance of the sheet S and the reference member 31 during skew correction may be stabilized, and the conveyance speed of the sheet S may be stabilized.

### Operation of Skew Feed Correcting Unit

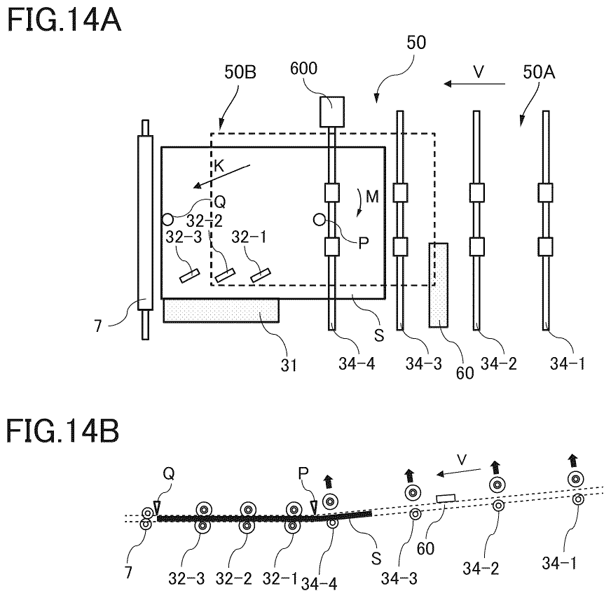

Next, skew correction operation of the skew feed correcting unit 50B in the registration unit 50 will be described with reference to FIGS. 14A and 14B. FIG. 14A is a top view illustrating a state in which skew correction has been performed in the skew feed correcting unit of the registration unit according to the first embodiment. FIG. 14B is a cross-sectional view of the state illustrated in FIG. 14A. In the present description of operation of the skew feed correcting unit, for example, a case is illustrated where skew correction of the sheet S having a large grammage, such as normal paper and thick paper, is performed in a state where all the skewing roller pairs 32-1 to 32-3 are in the nipping state to perform skew correction of the sheet S, as described in detail below.

As illustrated in FIGS. 14A and 14B, in the registration unit 50, the sheet S is conveyed in a direction inclined with respect to the sheet conveyance direction V illustrated by the arrow K direction in the drawing by the skewing roller pairs 32-1 to 32-3 in the nipping state, i.e., pressurizing state. Thereby, the side edge of the sheet S is abutted against and is in contact with the reference surface 31a of the reference member 31. In a state where skew correction is performed in the registration unit 50, the skewing roller pairs 32-1 to 32-3 are in the nipping state, and the conveyance roller pairs 34-1 to 34-4 are in the non-nipping state. Therefore, in the registration unit 50, by performing skew correction by the skewing roller pairs 32-1 to 32-3 after the conveyance roller pairs 34-1 to 34-4 are separated, skew correction may be performed without being interfered by the conveyance roller pairs 34-1 to 34-4.

### Operation of Registration Roller Pair

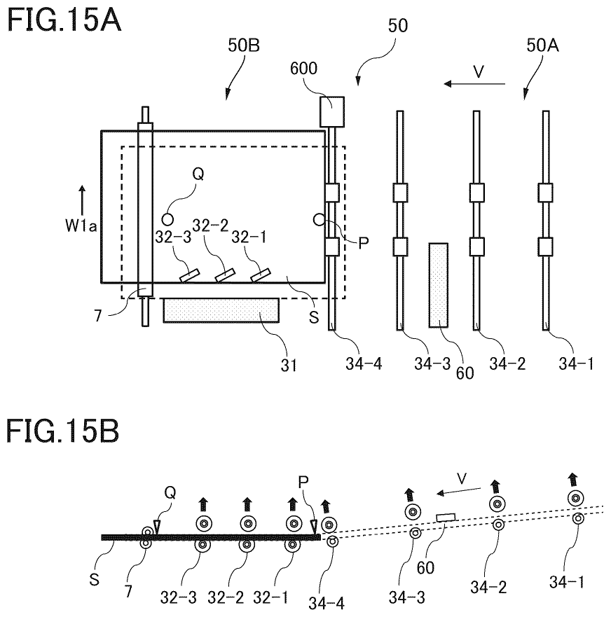

Next, a positioning operation of the sheet in the width direction of the registration roller pair 7 in the registration unit 50 will be described with reference to FIGS. 15A and 15B. FIG. 15A is a top view illustrating a state in which shifting operation has been performed by the registration roller pair of the registration unit according to the first embodiment. FIG. 15B is a cross-sectional view of the state illustrated in FIG. 15A.

As illustrated In FIGS. 15A and 15B, the sheet S is shifted in the direction of arrow W1a in the drawing by the registration roller pair 7 such that the width direction position of the sheet S corresponds to the width direction position of the image being transferred at the secondary transfer portion 1C (refer to FIG. 1). That is, the registration roller pair 7 performs shift operation after performing skew correction in the arrow W1a direction while conveying the sheet S in the sheet conveyance direction V such that the sheet position corresponds to the width direction position of the image being formed in the image forming engine 513 (refer to FIG. 1). Thereby, the image may be formed on the sheet S in a state where the registration unit 50 has aligned the width direction position of the sheet S having been subjected to skew correction with the width direction position of the image formed by the image forming engine 513 and transferred at the secondary transfer portion 1C.

According to the present embodiment, after setting the skewing roller pairs 32-1 to 32-3 to the non-nipping state, i.e., to a separated state, the width direction position of the sheet S is shifted by the registration roller pair 7. Therefore, the width direction position may be shifted without being interfered by the skewing roller pairs 32-1 to 32-3.

### Control of Registration Unit in Print Job

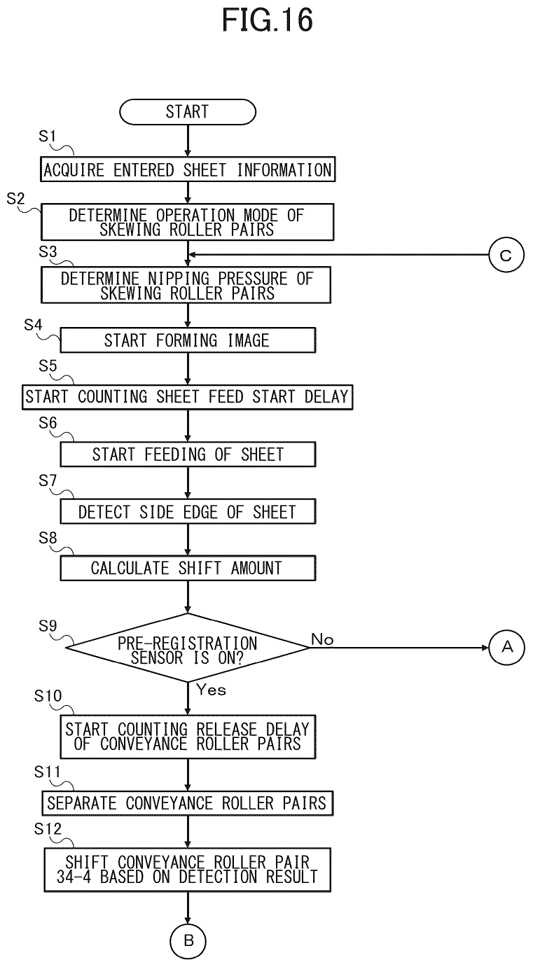

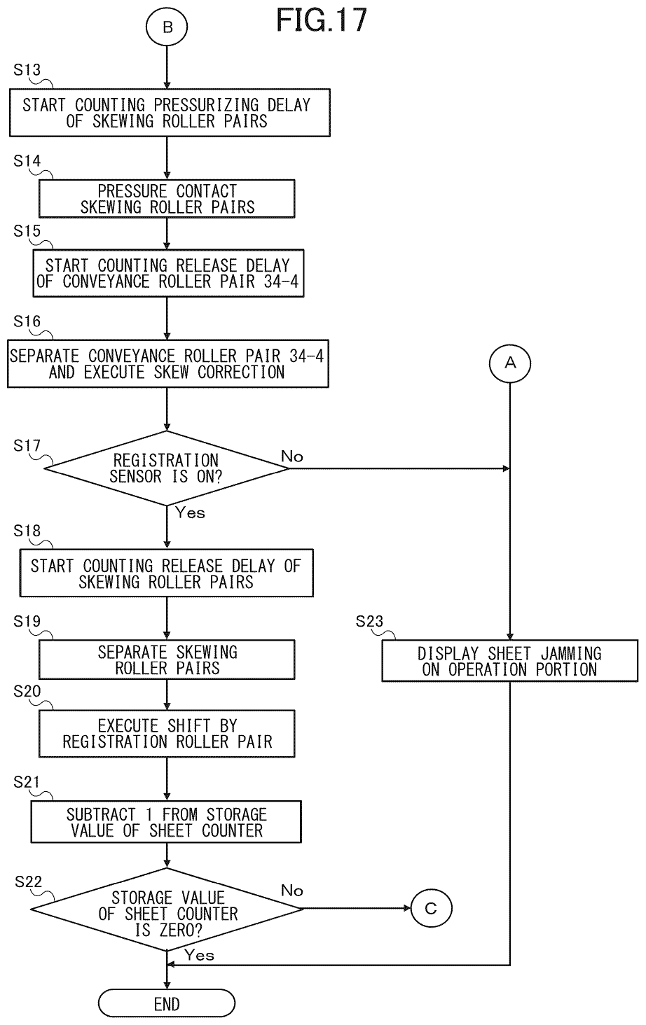

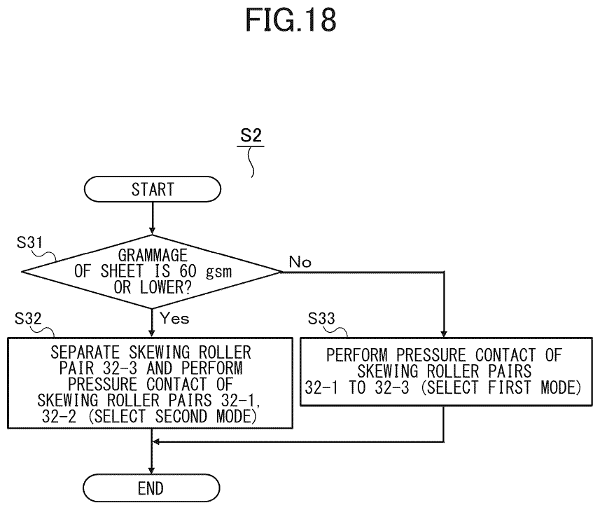

Next, the control of the registration unit 50 in a case where a command to perform printing of one or more sheets is sent to the control unit 9 from an external computer or the operation portion 400 and where the print job is executed will be described in detail with reference to FIGS. 16, 17, and 18. FIG. 16 is a flowchart illustrating the control of the conveyance unit of the registration unit when executing a regular print job according to the first embodiment. FIG. 17 is a flowchart illustrating the control of the skew feed correcting unit and the registration roller pair of the registration unit during execution of a regular print job according to the first embodiment. FIG. 18 is a flowchart illustrating the control of determination of operation mode of the skewing roller pair according to the first embodiment.

### Operation of Conveyance Unit of Registration Unit

At first, the control unit 9 acquires information related to the sheet, hereinafter referred to as “sheet information”, from the information contained in the print job entered from the external computer or the operation portion 400, of information set in advance with respect to the sheet feed cassette 51 (S1). In this processing, the control unit 9 acquires the sheet information including the grammage, the size, the number, and the type of sheets. Among the sheet information, the sheet type information contains information indicating whether the sheet type is a normal paper used in offices, coated paper, thick paper, or thin paper. Further, the control unit 9 acquires the number of sheets that are passed through the registration unit 50 in the print job being started based on the number of sheets information included in the sheet information, and sets the value as an initial value of a storage value which is the value being stored in a sheet counter.

Next, the control unit 9 determines the operation mode of the skewing roller pairs 32-1 to 32-3 (S2). This operation mode of the skewing roller pairs 32-1 to 32-3 is performed by executing an operation mode determination control of the skewing roller pair illustrated in FIG. 18. As illustrated in FIG. 18, the control unit 9 determines whether the grammage of the sheet S is 60 gsm or lower based on the sheet information acquired as above (S31). If the grammage of the sheet S is 60 gsm or lower (S31; Yes), it is determined that the skewing roller pair 32-3 are to be separated, and that the skewing roller pairs 32-1 and 32-2 are to be in pressure contact (S32). That is, the second mode is selected and determined as the operation mode. Meanwhile, if the grammage of the sheet S is not 60 gsm or lower (S31: No), it is determined that all the skewing roller pairs 32-1, 32-2, and 32-3 are to be in pressure contact (S33). That is, a first mode is selected and determined as the operation mode. That is, in the sheet oblique conveyance state, the control unit 9 selects and executes the first mode if a grammage of the sheet is a first grammage (e.g., more than 60 gsm), and the second mode if the grammage of the sheet is a second grammage that is less than the first grammage (e.g., equal to or less than 60 gsm).

When the operation mode of the skewing roller pair is determined as described above, the control unit 9 determines a nipping pressure of the skewing roller pairs 32-1 to 32-3 (S3). In this processing, the control unit 9 acquires from the ROM 9c a table data in which nipping pressure is associated with each type of sheets set in advance based on the sheet information acquired in the process of step S1 and the determined operation mode, and determines the nipping pressure of the skewing roller pairs 32-1 to 32-3. Then, if the determined operation mode is the first mode, for example, the magnitude of the nipping pressure is determined for the skewing roller pairs 32-1 to 32-3, and if the determined operation mode is the second mode, the magnitude of nipping pressure is determined for the skewing roller pairs 32-1 to 32-2. The magnitude of the nipping pressure in each of the skewing roller pairs 32-1 to 32-3 is determined according to the sheet type and the grammage. That is, if the grammage is high and the surface is slippery, the nipping pressure of the skewing roller pairs 32-1 to 32-3 is set high.

Next, the control unit 9 starts to form an image by the image forming engine 513 (S4). The control unit 9 starts to count a sheet feed start delay based on a timing at which the processing of step S4 has been started (S5). The sheet feed start delay is a time difference between an elapsed time from the forming of image on the intermediate transfer belt 506 until the image is conveyed to the secondary transfer portion 1C and an elapsed time of conveyance of the sheet from the sheet feed cassette 51 to the secondary transfer portion 1C. The control unit 9 sets the value to be counted as the sheet feed start delay according to the image that has been started to be formed by the processing of step S4, and starts counting.

At a timing at which the count of the sheet feed start delay has reached the set value, the control unit 9 starts feeding of a sheet from the sheet feed cassette 51 (S6). The control unit 9 causes the sheet position detection sensor 60 to detect the side edge position of the sheet at a first timing at which the sheet has been conveyed to and reached the sheet position detection sensor 60 (S7). The reaching of the sheet to the sheet position detection sensor 60 may be detected by signal output from the sheet position detection sensor 60.

Next, the control unit 9 calculates a shift amount of the sheet (S8). In this processing, the control unit 9 calculates a misalignment amount to the zero point position set as the reference position of the sheet position detection sensor 60 based on the detection result of the sheet position detection sensor 60. Then, the control unit 9 determines a shift amount for shifting the conveyance roller pair 34-4 in the width direction orthogonal to the sheet conveyance direction according to the calculated misalignment amount.

After executing the processing of step S8, the control unit 9 determines whether the pre-registration sensor P has been turned ON (S9). In this processing, the control unit 9 determines based on the signal from the pre-registration sensor P whether the sheet whose side edge position has been detected by the sheet position detection sensor 60 has reached the pre-registration sensor P.

In the processing of step S9, if it is determined that the pre-registration sensor P has not been turned ON (S9: No), the control unit 9 determines that sheet jamming has occurred, since the sheet is not conveyed to the pre-registration sensor P at a timing that it should have been conveyed thereto. The control unit 9 displays on the operation portion 400 that sheet jamming has occurred (S23 of FIG. 17), and ends the present control.

Meanwhile, if it is determined that the pre-registration sensor P has been turned ON (S9: Yes), the control unit 9 starts to count a release delay of the conveyance roller pairs 34-1 to 34-3 (S10). At a point of time when the processing of S10 is executed, in the registration unit 50, the sheet has reached the pre-registration sensor P that is positioned downstream of the conveyance roller pair 34-4 in the sheet conveyance direction, such that shift operation prior to skew correction by the conveyance roller pair 34-4 is enabled. Therefore, in the processing of step S12, the control unit 9 sets the value of release delay, which is the elapsed time for the conveyance roller pairs 34-1 to 34-3 to change from the nipping state to the non-nipping state, and starts counting.

At a timing at which the release delay count of step S10 has reached the set value, the control unit 9 separates the driving rollers 13 and the driven rollers 14 of the conveyance roller pairs 34-1 to 34-3 to realize the non-nipping state (S11). Thereby, in the registration unit 50, a state is realized where the sheet is nipped by the conveyance roller pair 34-4 and not nipped by the conveyance roller pairs 34-1 to 34-3. That is, if the pre-registration sensor P detects that the sheet has arrived at the registration roller pair 7, the control unit 9 switches the conveyance roller pairs 34-1 to 34-3 to the non-nipping state, and moves the registration roller pair 7 by the slide mechanism 70.

Then, the control unit 9 shifts the conveyance roller pair 34-4 in the width direction by a shift amount corresponding to the detection result of the sheet position detection sensor 60 (S12). In this processing, the control unit 9 shifts the conveyance roller pair 34-4 by a shift amount calculated by the processing of step S8, and shifts the sheet such that the distance from the reference surface 31a of the reference member 31 to the side edge of the sheet is set to a predetermined distance, that is, to a zero point position serving as the reference position.

In the present embodiment, in step S12, the sheet is described as being conveyed while being shifted in the width direction by the conveyance roller pair 34-4. Alternatively, in order to stabilize the shifting of the sheet, it may be possible to stop the conveyance of the sheet before shifting the sheet by the conveyance roller pair 34-4, and thereafter, resume conveyance of the sheet.

### Operation of Skew Feed Correcting Unit and Registration Roller Pair in First Mode

Next, the procedure advances to step S13 and subsequent steps illustrated in FIG. 17, and performs control of the skew feed correcting unit and the registration roller pair 7. In the following description, a case is described in which the first mode has been selected and set in step S2 described above as the operation mode of the skewing roller pair, and a case in which the second mode has been selected and set will be described later.

After executing the processing of step S12, as illustrated in FIG. 17, the control unit 9 starts counting a pressurizing delay of the skewing roller pairs 32-1 to 32-3 (S13). At a point of time when the processing of step S13 is executed, in the registration unit 50, the shift prior to performing skew correction of the sheet has been completed. Further, in the registration unit 50, the skewing roller pairs 32-1 to 32-3 are in the non-nipping state so as to prevent the skewing roller pairs 32-1 to 32-3 from interfering with the shifting operation performed by the conveyance roller pair 34-4. Therefore, in the processing of step S13, the control unit 9 sets the value of the pressurizing delay, which is a time elapsed for the skewing roller pairs 32-1 to 32-3 to change from the non-nipping state to the nipping state, and starts counting.

Next, at a timing at which the counting of the pressurizing delay is ended, the control unit 9 causes the driving rollers 320-1 to 320-3 and the driven rollers 331-1 to 331-3 of the skewing roller pairs 32-1 to 32-3 to be in pressure contact with each other (S14). Further, the control unit 9 starts counting the release delay, which is a time required for the conveyance roller pair 34-4 to change from the nipping state to the non-nipping state (S15). Then, at a timing at which the counting of the release delay is ended, the lower roller 402 and the upper roller 401 of the conveyance roller pair 34-4 are separated, and oblique conveyance by the skewing roller pairs 32-1 to 32-3 is performed to execute skew correction (S16).

That is, by executing the processing of steps S13 to S16, in the registration unit 50, a state is realized where the sheet is not nipped by the conveyance roller pair 34-4 while the sheet may be nipped and conveyed by the skewing roller pairs 32-1 to 32-3. In the registration unit 50, by nipping and conveying the skewing roller pairs 32-1 to 32-3, skew correction of the sheet is performed in which the side edge of the sheet is abutted against the reference surface 31a of the reference member 31 while being conveyed.

Next, the control unit 9 determines whether the registration sensor Q has been turned ON (S17). In this processing, the control unit 9 determines based on the signal from the registration sensor Q whether the sheet having been subjected to skew correction by the skewing roller pairs 32-1 to 32-3 has reached the registration sensor Q.

In the processing of step S21, if it is determined that the registration sensor Q has not been turned ON (S17: No), the control unit 9 determines that sheet jamming has occurred since the sheet has not been conveyed to the registration sensor Q at a timing that is should have been conveyed thereto. In this case, the control unit 9 displays on the operation portion 400 that sheet jamming has occurred (S23), and ends the control processing regarding registration control and skew correction.

Meanwhile, if it is determined that the registration sensor Q has been turned ON (S17: Yes), the control unit 9 starts to count a release delay of the skewing roller pairs 32-1 to 32-3 (S18). At a point of time when the processing of S18 is executed, in the registration unit 50, the leading edge of the sheet has reached the registration sensor Q that is positioned downstream of the skewing roller pairs 32-1 to 32-3 in the sheet conveyance direction. Therefore, conveyance and shifting of the sheet by the registration roller pair 7 is enabled. That is, the control unit 9 continues the first mode or the second mode from when the sheet oblique conveyance state has ended until the sheet is conveyed to the registration roller pair 7. And, in response to the registration sensor Q detecting that the sheet has arrived at the registration roller pair 7, the control unit 9 is configured to move the registration roller pair 7 by the slide mechanism 70 to move the sheet in the width direction such that a position of the sheet aligns with a position in the width direction of an image to be formed on the sheet by the image forming engine 513. Thus, in the processing of step S18, the control unit 9 sets the value of release delay, which is the elapsed time for the skewing roller pairs 32-1 to 32-3 to change from the nipping state to the non-nipping state, and starts counting.

Next, at a timing at which the counting of the release delay is ended, the control unit 9 separates the driving rollers 320-1 to 320-3 and the driven rollers 331-1 to 331-3 of the skewing roller pairs 32-1 to 32-3 (S19). Thereby, in the registration unit 50, a state is realized where the sheet is nipped by the registration roller pair 7 and not nipped by the skewing roller pairs 32-1 to 32-3.

Then, the control unit 9 shifts the width direction position of the sheet after skew correction by the registration roller pair 7 such that the width direction position of the sheet corresponds to the width direction position of the image being transferred at the secondary transfer portion 1C (S20). In this processing, the control unit 9 shifts the width direction position of the sheet nipped by the registration roller pair 7 to a position corresponding to the center position in the width direction of the image formed by the image forming engine 513.

Next, the control unit 9 subtracts 1 from a number of passed sheets being counted by the sheet counter (S21). In this processing, since the series of skew correction operation for one sheet, in other words, the shifting prior to the skew correction, the skew correction, and shifting after the skew correction, is ended, the control unit 9 subtracts “1”, which is a value corresponding to one sheet, from the storage value of the sheet counter.

Thereafter, the control unit 9 determines whether the storage value of the sheet counter is zero (S22). In the present processing, if it is determined that the storage value of the sheet counter is not zero (S22: No), the control unit 9 returns the processing to step S3 to execute the series of skew correction operations to a sheet that is subsequently conveyed in the present print job. Meanwhile, if it is determined that the storage value of the sheet counter is zero (S22: Yes), the control unit 9 determines that the current print job has been completed, and ends the present control.

### Problem Regarding Sheet having Small Grammage

As described above, in a case where the sheet S conveyed from the conveyance roller pair 34-4 to the skewing roller pairs 32-1 to 32-3 of the skew feed correcting unit 50B is a sheet having a grammage of 60 gsm or higher, such as normal paper and thick paper, the first mode is selected. Then, the skewing roller pairs 32-1 to 32-3 convey the sheet S in a state where all three roller pairs are in pressure contact, i.e., in the nipping state, at least until the edge portion in the width direction of the sheet S is abutted against the reference member 31. The sheet S having been obliquely conveyed toward the reference member 31 has its leading edge in the sheet conveyance direction abutted against the reference member 31, and the edge portion in the width direction turns in the direction of arrow M to be aligned with the reference member 31, as illustrated in FIG. 14A, by which the skewing of the sheet S is corrected.

In this state, as described above, the pressure by which the sheet S is nipped by the skewing roller pairs 32-1 to 32-3 may be changed by the respective pressurization mechanisms 33-n. Therefore, the obliquely conveying force, i.e., conveyance force in the oblique conveyance direction, applied by the skewing roller pairs 32-1 to 32-3 to the sheet S, in other words, the force by which the sheet is abutted against the reference member 31, hereinafter referred to as “abutting force”, may be set variably according to the grammage of the sheet S. In other words, the abutting force is controlled to be set to a predetermined force with respect to the grammage of the sheet S.

A buckling force after the sheet S has been abutted against the reference member 31, hereinafter referred to as buckling load, tends to be reduced as the grammage of the sheet S becomes smaller, such that the nipping pressure is set so that the abutting force becomes smaller as the grammage reduces. However, there is a limit in the range in which the abutting force may be reduced by changing the nipping pressure by the skewing roller pairs 32-1 to 32-3. Therefore, when conveying a sheet S having a grammage of 60 gsm or lower, such as thin paper, even if the nipping pressure is lowered as much as possible to reduce the abutting force, the abutting force applied by the skewing roller pairs 32-1 to 32-3 to the sheet S will still exceed the buckling load of the sheet S. Therefore, the sheet S having been obliquely conveyed and abutted against the reference member 31 may be buckled, and thereby, the accuracy of skew correction may be deteriorated.

Therefore, according to the present embodiment, a second mode may be executed as the operation mode of the skewing roller pairs 32-1 to 32-3, by which the abutting force applied by the skewing roller pairs 32-1 to 32-3 may be reduced. The following description illustrates the operation of the skew feed correcting unit according to the second mode.

### Operation of Skew Feed Correcting Unit by Second Mode

As described above, when the control of the registration unit 50 in the print job is started (refer to FIG. 16), the control unit 9 acquires the sheet information (S1), and determines the operation mode of the skewing roller pairs 32-1 to 32-3 according to the sheet information (S2). When it is determined that the sheet S is a sheet having a small grammage, such as a thin sheet, and the grammage of the sheet S is 60 gsm or smaller (S31: Yes), as illustrated in FIG. 18, a second mode is selected and determined as the operation mode (S32). The second mode is a mode of controlling the skewing roller pair 32-3 to be in the non-nipping state in the sheet oblique conveyance state. In step S32, the separation of the skewing roller pair 32-3 and the pressure contact of the skewing roller pairs 32-1 and 32-2 are determined.

Thereafter, when the operation of the conveyance unit 50A of the registration unit 50 (S3 to S12) is ended, as illustrated in FIG. 17, the operation of the skew feed correcting unit 50B according to the second mode is started. That is, the control unit 9 starts counting the pressurizing delay of the skewing roller pairs 32-1 to 32-3 (S13). In this state, in the registration unit 50, the skewing roller pairs 32-1 to 32-3 are in a non-nipping state so as to prevent the skewing roller pairs 32-1 to 32-3 from interfering with the shifting of the conveyance roller pair 34-4. Therefore, in the processing of step S13, the control unit 9 sets the value of the pressurizing delay, which is the time elapsed for the skewing roller pairs 32-1 to 32-3 to change from the non-nipping state to the nipping state, and starts counting.

Next, at a timing at which the counting of the pressurizing delay is ended, since the second mode is determined as the operation mode as described above, the control unit 9 performs pressure contact of the skewing roller pairs 32-1 and 32-2 while maintaining the skewing roller pair 32-3 in the separated state (S14). That is, the pressurization mechanisms 33-1 and 33-2 of the skewing roller pairs 32-1 and 32-2 are driven, such that the driving rollers 320-1 and 320-2 and the driven rollers 331-1 and 331-2 are in pressure contact.

Further, the control unit 9 starts counting the release delay, which is the time elapsed for the conveyance roller pair 34-4 to change from the nipping state to the non-nipping state (S15). At a timing when the counting of the release delay is ended, the lower roller 402 and the upper roller 401 of the conveyance roller pair 34-4 is separated, and oblique conveyance by the skewing roller pairs 32-1 and 32-2 are performed to execute the skew correction (S16).

That is, by executing the processes of steps S13 to S16, in the registration unit 50, the sheet is not nipped by the conveyance roller pair 34-4, and the sheet may be nipped and conveyed by the skewing roller pairs 32-1 and 32-2. In the present second mode, since the skewing roller pair 32-3 is separated so as not to apply abutting force to the sheet S, the abutting force against the reference member 31 applied to the sheet S only by the skewing roller pairs 32-1 and 32-2 is small compared to the first mode. In conclusion, since there are only two skewing roller pairs 32-1 and 32-2 applying abutting force to the sheet S, the abutting force is reduced to ⅔. In other words, if the abutting force applied to the sheet S by one of the skewing roller pairs 32-1 to 32-3 is referred to as x (N), and the buckling load of the sheet S is referred to as y (N), a type of sheet whose buckling load is within the range of 2x≤y may be processed by the second mode.

According to the present embodiment, a state from when the skewing roller pairs 32-1 to 32-2 start the oblique conveyance of the sheet having been conveyed by the skewing roller pairs 32-1 to 32-2 until the edge portion in the width direction of the sheet S abuts, or aligned with, the reference member 31, is defined as an oblique conveyance state of the sheet, hereinafter referred to as “sheet oblique conveyance state”. In other words, the sheet oblique conveyance state refers to a state from the movement in the width direction of the sheet S by the conveyance roller pair 34-4 until the edge portion of the sheet S is abutted against the reference member 31. That is, the control unit 9 enters the sheet oblique conveyance state after moving the sheet in the width direction by the skewing roller pair 32-1. In the present embodiment, the state from when the edge portion in the width direction of the sheet S has been abutted against the reference member 31 until the sheet is abutted against the registration roller pair 7 is defined as a post skew-correction state serving as a post-abutment conveyance state, since the skew correction of the sheet S is already ended. In the present embodiment, when the first mode or the second mode is selected, the nipping state or the non-nipping state of the skewing roller pairs 32-1 to 32-3 are maintained as they are in both the sheet oblique conveyance state and the post skew-correction state.

That is, according to the present embodiment, in the first mode, the skewing roller pairs 32-1 to 32-3 are set to the nipping state in the sheet oblique conveyance state, and the skewing roller pairs 32-1 to 32-3 maintain the nipping state also in the post skew-correction state. Further, in the second mode, the skewing roller pairs 32-1 and 32-2 are set to the nipping state in the sheet oblique conveyance state and the skewing roller pair 32-3 is set to the non-nipping state, and the skewing roller pairs 32-1 and 32-2 maintain the nipping state also in the post skew-correction state. Thereby, it becomes possible to reduce the occurrence of buckling in a state where the sheet S is abutted against the reference member 31 in the sheet oblique conveyance state, and even in the post skew-correction state, it becomes possible to reduce the occurrence of buckling by the sheet S being pressed further against the reference member 31.

The present embodiment illustrates a case in which the states of the skewing roller pairs 32-1 to 32-3 are maintained as they are both in the sheet oblique conveyance state and post skew-correction for both the first mode and the second mode, but the present technique is not limited thereto. That is, after executing the first mode or the second mode in the sheet oblique conveyance state, it may be possible to even further reduce the conveyance force pressing the sheet S against the reference member 31 by the skewing roller pairs 32-1 to 32-3 in the post skew-correction state. In other words, it may be possible to switch the skewing roller pair 32-2 from the nipping state to the non-nipping state, or to reduce the nipping pressure of the skewing roller pairs 32-1 and 32-2. In contrast, since buckling caused by the shock when the sheet S is abutted against the reference member 31 does not occur in the post skew-correction state, the conveyance force in which the sheet S is pressed against the reference member 31 by the skewing roller pairs 32-1 to 32-3 may be increased. That is, it may be possible to switch the skewing roller pair 32-3 from the non-nipping state to the nipping state, or to increase the nipping pressure of the skewing roller pairs 32-1 and 32-2.

As described, when the operation of the skew feed correcting unit 50B is ended, that is, when the sheet oblique conveyance state and the post skew-correction are ended, the procedure advances to the control of step S17 and subsequent steps described above. In other words, the procedure advances to perform control to shift the width direction position of the sheet nipped by the registration roller pair 7, but since this control is similar both in the first mode and the second mode, descriptions thereof are omitted.

### Summary of First Embodiment

As described above, according to the first embodiment, the state after starting oblique conveyance of the sheet conveyed by the conveyance roller pair 34-4 until the width direction edge portion of the sheet is abutted against the reference member 31 is referred to as the sheet oblique conveyance state. In the sheet oblique conveyance state, the control unit 9 is capable of executing the first mode in which the skewing roller pairs 32-1 and 32-3 are controlled to the nipping state. Further, in the sheet oblique conveyance state, the control unit 9 is capable of executing the second mode in which the skewing roller pair 32-1 is set to the nipping state and the skewing roller pair 32-3 is set to the non-nipping state. Thereby, in the sheet oblique conveyance state in which a sheet S having a small grammage, such as thin paper, is abutted against the reference member 31, the abutting force of the sheet S may be made small by selecting the second mode. Thereby, the occurrence of buckling of the sheet S may be reduced, and the deterioration of accuracy of skew correction may be prevented.

According further to the present first embodiment, in the first mode of the sheet oblique conveyance state, the control unit 9 controls the skewing roller pairs 32-1 to 32-3 to be in the nipping state. Further, in the second mode, the control unit 9 controls the skewing roller pairs 32-1 and 32-2 to be in the nipping state and the skewing roller pair 32-3 to be in the non-nipping state. Thereby, by selecting the second mode in the sheet oblique conveyance state, the abutting force by which sheet S is abutted against the reference member 31 may be reduced to ⅔, and the occurrence of buckling of the sheet S may be reduced.

Moreover, according to the present first embodiment, in the second mode of the sheet oblique conveyance state, the skewing roller pair 32-3 arranged downstream of the skewing roller pair 32-1 in the sheet conveyance direction is controlled to the non-nipping state. Thereby, conveyance of the sheet S from the conveyance roller pair 34-4 to the skew feed correcting unit 50B may be performed reliably. Further, when the skewing roller pair 32-3 is controlled to the nipping state, there is a possibility that the abutting force by which the sheet S is abutted against the reference member 31 may become high at the final stage, and buckling of the sheet may tend to occur. However, by setting the third skewing roller pair 32-3 among the skewing roller pairs 32-1 to 32-3 to the non-nipping state, it becomes possible to prevent the abutting force from becoming high immediately before the sheet S is abutted against the reference member 31, such that the occurrence of buckling of the sheet may be reduced.

### Second Embodiment

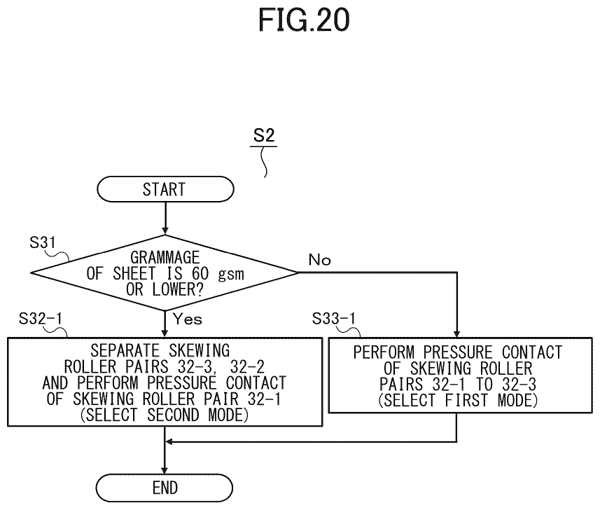

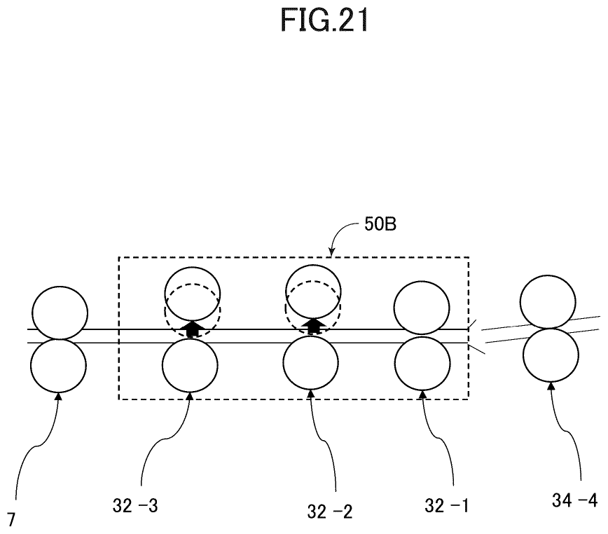

Next, a second embodiment in which a portion of the first embodiment is varied will be described with reference to FIGS. 20 and 21. FIG. 20 is a flowchart illustrating a mode determination control of a skewing roller pair according to a second embodiment. FIG. 21 is a schematic cross-sectional view illustrating a state of a skew feed correcting unit in a second mode according to the second embodiment. In the description of the present second embodiment, the same components as the first embodiment are denoted with the same reference numbers, and descriptions thereof are omitted.

According to the first embodiment, an example has been described of a case where, in the second mode, one of the skewing roller pairs 32-1 to 32-3 are in a separated state, or non-nipping state, and the other two are in a pressure contact state, or nipping state. In contrast, according to the present second embodiment, in the second mode, two of the skewing roller pairs 32-1 to 32-3 are in the separated state, or non-nipping state, and one is in the pressure contact state, or nipping state.

Specifically, when the control of the registration unit 50 in a print job is started (refer to FIG. 16), the control unit 9 acquires a sheet information (S1), and determines the operations mode of the skewing roller pairs 32-1 to 32-3 according to the sheet information (S2). As illustrated in FIG. 20, if the sheet S is a sheet having a small grammage, such as thin paper, and it is determined that the grammage of the sheet S is 60 gsm or smaller (S31: Yes), the second mode is selected and determined as the operation mode (S32-1). According to the step S32-1, the separation of the skewing roller pairs 32-3 and 32-2 and the pressure contact of the skewing roller pair 32-1 are determined. The first mode (S33-1) is similar to the first embodiment, such that detailed descriptions thereof are omitted.

Thereafter, when the operation (S3 to S12) of the conveyance unit 50A of the registration unit 50 is ended, as illustrated in FIG. 17, the operation of the skew feed correcting unit 50B in the second mode is started. That is, the control unit 9 starts counting the pressurizing delay of the skewing roller pairs 32-1 to 32-3 (S13). In this state, in the registration unit 50, the skewing roller pairs 32-1 to 32-3 are in a non-nipping state so as to prevent the skewing roller pairs 32-1 to 32-3 from interfering with the shifting of the conveyance roller pair 34-4. Therefore, in the processing of step S13, the control unit 9 sets the value of the pressurizing delay, which is the elapsed time for the skewing roller pairs 32-1 to 32-3 to change from the non-nipping state to the nipping state, and starts counting.

Next, at a timing at which the counting of the pressurizing delay is ended, since the second mode is determined as the operation mode, the control unit 9 realizes pressure contact of the skewing roller pair 32-1 while maintaining the skewing roller pairs 32-3 and 32-2 in the separated state (S14). That is, the control unit 9 drives the pressurization mechanism 33-1 of the skewing roller pair 32-1 and realizes pressure contact of the driving roller 320-1 and the driven roller 331-1.

Further, the control unit 9 starts counting the release delay, which is the time required for the conveyance roller pair 34-4 to change from the nipping state to the non-nipping state (S15). At a timing at which the counting of the release delay is ended, the lower roller 402 and the upper roller 401 of the conveyance roller pair 34-4 are separated, and oblique conveyance by the skewing roller pair 32-1 is performed to execute skew correction (S16).

That is, by executing the processing of steps S13 to S16, in the registration unit 50, a state is realized where the conveyance roller pair 34-4 does not nip the sheet while the skewing roller pair 32-1 may nip and convey the sheet. According to the present second mode, the skewing roller pairs 32-3 and 32-2 are separated and do not apply abutting force to the sheet S, such that the abutting force against the reference member 31 applied to the sheet S by only the skewing roller pair 32-1 is made small compared to the first mode. That is, since there is only one skewing roller pair 32-1 applying abutting force to the sheet S, the abutting force is reduced to ⅓. In other words, if the abutting force applied to the sheet S by one of the skewing roller pairs 32-1 to 32-3 is referred to as x (N), and the buckling load of the sheet S is referred to as y (N), a type of sheet whose buckling load is within the range of x≤y may be processed by the present second mode.

Even according to the present second embodiment, in the first mode, the skewing roller pairs 32-1 to 32-3 are set to the nipping state in the sheet oblique conveyance state, and the skewing roller pairs 32-1 to 32-3 maintain the nipping state even in the post skew-correction state. Further, in the second mode, only the skewing roller pair 32-1 is set to the nipping state and the skewing roller pairs 32-3 and 32-2 are in the non-nipping state in the sheet oblique conveyance state, and the skewing roller pair 32-1 maintains the nipping state even in the post skew-correction state. Thereby, in the sheet oblique conveyance state, the occurrence of buckling when the sheet S is abutted against the reference member 31 may be reduced, and even in the post skew-correction state, the occurrence of buckling caused by the sheet S being pushed further against the reference member 31 may be reduced.

According to the present second embodiment, the states of the skewing roller pairs 32-1 to 32-3 have been maintained as they are both in the sheet oblique conveyance state and the post skew-correction and both in the first mode and the second mode, but the present technique is not limited thereto. That is, after executing the first mode or the second mode in the sheet oblique conveyance state, the conveyance force in the direction pressing the sheet S against the reference member 31 by the skewing roller pairs 32-1 to 32-3 may be reduced further in the post skew-correction state. That is, the nipping pressure of the skewing roller pair 32-1 may be reduced. In contrast, in the post skew-correction state, buckling caused by impact of the sheet S being abutted against the reference member 31 does not occur, such that the conveyance force in the direction pushing the sheet S against the reference member 31 by the skewing roller pairs 32-1 to 32-3 may be increased. That is, it may be possible to switch the skewing roller pair 32-3 and/or the skewing roller pair 32-2 from the non-nipping state to the nipping state, or to increase the nipping pressure of the skewing roller pair 32-1.

### Summary of Second Embodiment

As described above, according to the second embodiment, in the sheet oblique conveyance state, the control unit 9 is capable of executing the first mode in which the skewing roller pairs 32-1 to 32-3 are controlled to the nipping state. Further, in the sheet oblique conveyance state, the control unit 9 is capable of executing the second mode in which the skewing roller pair 32-1 is set to the nipping state and the skewing roller pairs 32-2 and 32-3 are set to the non-nipping state. Thereby, in the sheet oblique conveyance state in which a sheet S having a small grammage, such as thin paper, is abutted against the reference member 31, the abutting force of the sheet S may be made small by selecting the second mode. Thereby, the occurrence of buckling of the sheet S may be reduced, and the deterioration of accuracy of skew correction may be prevented.

The other configurations, operations, and effects according to the second embodiment are similar to the first embodiment described above, such that descriptions thereof are omitted.

### Other Embodiments

In the first and second embodiments described above, an example in which the registration unit 50 has three skewing roller pairs 32-1 to 32-3 has been described. However, the present technique is not limited thereto, and the number of the skewing roller pairs may be any number of two or more. If there are two or more skewing roller pairs, in the sheet oblique conveyance state, the second mode may be executed by setting one of the plurality of skewing roller pairs to be separated, i.e., in the non-nipping state.

According further to the first and second embodiments, in the second mode, the skewing roller pair 32-3 which is arranged most downstream of the skewing roller pairs in the sheet conveyance direction is set to be separated, i.e., in the non-nipping state. However, the present technique is mot limited thereto, and in the second mode, the skewing roller pair at any position of the two skewing roller pairs may be separated, i.e., set to the non-nipping state. For example, in the configuration including the skewing roller pairs 32-1 to 32-3, in the second mode, the skewing roller pair 32-1 may be separated, i.e., set to the non-nipping state. Further, if the sheet size is included in the sheet information, it may be possible to determine which skewing roller pair among the skewing roller pairs 32-1 to 32-3 is to be separated according to the sheet size. Moreover, if the sheet surface roughness is included in the sheet information, it may be possible to determine which skewing roller pair among the skewing roller pairs 32-1 to 32-3 is to be separated according to the sheet surface roughness.

In the first and second embodiments, an example has been illustrated where the operation mode executed in the sheet oblique conveyance state is selectively determined from the first mode and the second mode according to the grammage of the sheet. However, the present technique is not limited thereto, and the first mode and the second mode may be selectively determined based on any information included in the sheet information. For example, the first mode and the second mode may be determined selectively based on the sheet size. Further, the first mode and the second mode may be selectively determined based on the sheet surface roughness. Even further, the first mode and the second mode may be determined selectively based on the combination of multiple items included in the sheet information. That is, the control unit 9 is configured to selectively execute the first mode and the second mode based on an information regarding the sheet to be obliquely conveyed in the sheet oblique conveyance state.

Further according to the first and second embodiments, an example has been illustrated where the width direction position of the reference member 31 is fixed, but the present technique is not limited thereto, and a configuration may be adopted in which the reference member 31 is moved in the width direction. For example, instead of adjusting the width direction position of the sheet by the conveyance roller pair 34-4, the reference member 31 may be moved in the width direction according to the detection result of the sheet position detection sensor 60. That is, by moving the reference member 31 in the width direction, it may be possible to fix the relative distance between the sheet and the reference member 31, such that the distance in which the sheet is obliquely conveyed by the skewing roller pair may be fixed.

According to the first and second embodiments, an example has been illustrated where the registration unit 50 performed skew correction at a position upstream of the secondary transfer portion 1C. However, the present technique is not limited thereto, and for example, skew correction may be performed upstream of a processing unit for performing cutting, binding, punching, or folding the sheets, or upstream of the image reading unit.

According further to the present embodiment, an example has been illustrated where the printer 1 is a full-color laser beam printer based on an electrophotographic system, but the present technique is not limited thereto. For example, the configuration and system of the image forming unit for forming an image on a sheet may be any system, such as an inkjet printer.

The present disclosure may be realized by providing a program for realizing one or more functions of the embodiments described above to a system or an apparatus via a network or a storage medium, and to have one or more processors of the system or a computer or the apparatus read and execute the program. Further, the present disclosure may also be realized via a circuit, such as ASIC, that realizes one or more functions.

According to the present disclosure, it may be possible to prevent deterioration of accuracy of skew correction.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-133340, filed Aug. 8, 2024 which is hereby incorporated by reference herein in its entirety.

What is claimed is:

1. A sheet conveyance apparatus comprising:
a first conveying rotary member pair configured to nip and convey a sheet;
an abutment portion arranged on one side in a width direction orthogonal to a sheet conveyance direction with respect to the sheet being conveyed;
a first skewing rotary member pair arranged downstream of the first conveying rotary member pair in the sheet conveyance direction and configured to obliquely convey the sheet toward the abutment portion;
a second skewing rotary member pair arranged downstream of the first conveying rotary member pair in the sheet conveyance direction and configured to obliquely convey the sheet toward the abutment portion;
a switching mechanism configured to switch the second skewing rotary member pair between a nipping state in which the sheet is nipped and conveyed and a non-nipping state in which the nipping of the sheet is released; and
a control unit configured to control the switching mechanism,
wherein the control unit is configured to execute
a first mode of controlling the second skewing rotary member pair to be in the nipping state in a sheet oblique conveyance state which is a state from when the first skewing rotary member pair starts an oblique conveyance of the sheet having been conveyed by the first conveying rotary member pair until an edge portion in the width direction of the sheet abuts the abutment portion, and
a second mode of controlling the second skewing rotary member pair to be in the non-nipping state in the sheet oblique conveyance state.

2. The sheet conveyance apparatus according to claim 1, wherein the second skewing rotary member pair is arranged downstream of the first skewing rotary member pair in the sheet conveyance direction.

3. The sheet conveyance apparatus according to claim 2, wherein the second skewing rotary member pair is arranged at a position where at least a portion of the second skewing rotary member pair overlaps with the first skewing rotary member pair when viewed in the sheet conveyance direction.

4. The sheet conveyance apparatus according to claim 1, further comprising:
a third skewing rotary member pair arranged downstream of the first conveying rotary member pair in the sheet conveyance direction and configured to obliquely convey the sheet toward the abutment portion,
wherein, in the first mode, the first skewing rotary member pair, the second skewing rotary member pair, and the third skewing rotary member pair are configured to nip and convey the sheet, and
wherein, in the second mode, the first skewing rotary member pair and the third skewing rotary member pair are configured to nip and convey the sheet.

5. The sheet conveyance apparatus according to claim 4,
wherein the second skewing rotary member pair is arranged downstream of the first skewing rotary member pair in the sheet conveyance direction, and
wherein the third skewing rotary member pair is arranged downstream of the first skewing rotary member pair and upstream of the second skewing rotary member pair in the sheet conveyance direction.

6. The sheet conveyance apparatus according to claim 5,
wherein the second skewing rotary member pair is arranged at a position where at least a portion of the second skewing rotary member pair overlaps with the first skewing rotary member pair when viewed in the sheet conveyance direction, and
wherein the third skewing rotary member pair is arranged at a position where at least a portion of the third skewing rotary member pair overlaps with the second skewing rotary member pair when viewed in the sheet conveyance direction.

7. The sheet conveyance apparatus according to claim 1, further comprising:
a third skewing rotary member pair arranged downstream of the first conveying rotary member pair in the sheet conveyance direction and configured to obliquely convey the sheet toward the abutment portion,
wherein the switching mechanism is configured to switch the third skewing rotary member pair between a nipping state in which the sheet is nipped and conveyed and a non-nipping state in which the nipping of the sheet is released,
wherein, in the first mode, the control unit is configured to control the second skewing rotary member pair and the third skewing rotary member pair to be in the nipping state, and
wherein, in the second mode, the control unit is configured to control the second skewing rotary member pair and the third skewing rotary member pair to be in the non-nipping state in the second mode.

8. The sheet conveyance apparatus according to claim 7,
wherein the second skewing rotary member pair is arranged downstream of the first skewing rotary member pair in the sheet conveyance direction, and
wherein the third skewing rotary member pair is arranged downstream of the first skewing rotary member pair and upstream of the second skewing rotary member pair in the sheet conveyance direction.

9. The sheet conveyance apparatus according to claim 8,
wherein the second skewing rotary member pair is arranged at a position where at least a portion of the second skewing rotary member pair overlaps with the first skewing rotary member pair when viewed in the sheet conveyance direction, and
wherein the third skewing rotary member pair is arranged at a position where at least a portion of the third skewing rotary member pair overlaps with the second skewing rotary member pair when viewed in the sheet conveyance direction.

10. The sheet conveyance apparatus according to claim 1, wherein the control unit is configured to selectively execute the first mode and the second mode based on an information regarding the sheet to be obliquely conveyed in the sheet oblique conveyance state.

11. The sheet conveyance apparatus according to claim 1, wherein, in the sheet oblique conveyance state, the control unit is configured to select and execute the first mode in a state where a grammage of the sheet is a first grammage, and to select and execute the second mode in a state where the grammage of the sheet is a second grammage that is less than the first grammage.

12. The sheet conveyance apparatus according to claim 1, further comprising:
a first movement unit configured to move the first conveying rotary member pair in the width direction; and
a width position detecting unit configured to detect a position of the edge portion in the width direction of the sheet being nipped by the first conveying rotary member pair,
wherein the control unit is configured to
detect the position of the edge portion in the width direction of the sheet by the width position detecting unit,
move the first conveying rotary member pair nipping the sheet by the first movement unit to move the sheet in the width direction such that the position of the edge portion is set to a set position that is separated from the abutment portion in the width direction, and
enter the sheet oblique conveyance state after moving the sheet in the width direction by the first conveying rotary member pair.

13. The sheet conveyance apparatus according to claim 12, further comprising:
another switching mechanism configured to switch the first conveying rotary member pair between a nipping state in which the sheet is nipped and conveyed and a non-nipping state in which the nipping of the sheet is released,
wherein the control unit is configured to switch the first conveying rotary member pair to the non-nipping state by the another switching mechanism in the sheet oblique conveyance state.

14. The sheet conveyance apparatus according to claim 1, further comprising:
a second conveying rotary member pair configured to nip and convey the sheet being abutted against the abutment portion;
a second movement unit configured to move the second conveying rotary member pair in the width direction; and
a detecting unit configured to detect that the sheet has arrived at the second conveying rotary member pair,
wherein the control unit is configured to
continue the first mode or the second mode from when the sheet oblique conveyance state has ended until the sheet is conveyed to the second conveying rotary member pair, and
in response to the detecting unit detecting that the sheet has arrived at the second conveying rotary member pair, move the second conveying rotary member pair by the second movement unit to move the sheet in the width direction such that a position of the sheet aligns with a position in the width direction of an image to be formed on the sheet by an image forming unit.

15. The sheet conveyance apparatus according to claim 14,
wherein the switching mechanism is configured to switch the first skewing rotary member pair between a nipping state in which the sheet is nipped and conveyed and a non-nipping state in which the nipping of the sheet is released, and
wherein upon the detecting unit detecting that the sheet has arrived at the second conveying rotary member pair, the control unit is configured to switch the first skewing rotary member pair and the second skewing rotary member pair to the non-nipping state, and move the second conveying rotary member pair by the second movement unit.

16. An image forming apparatus comprising:
the sheet conveyance apparatus according to claim 1; and
an image forming unit arranged downstream of the sheet conveyance apparatus in the sheet conveyance direction, and configured to form an image on the sheet.
